(19) United States
(12) Patent Application Publication
(10) Pub. No.: US 2025/0280826 A1
(43) Pub. Date: Sep. 11, 2025

(54) PLANT GROWTH PROMOTER

(71) Applicant: KAO CORPORATION, Tokyo (JP)

(72) Inventors: Haruka MAEDA, Haga-gun (JP); Atsuki OHNISHI, Haga-gun (JP); Teruhisa FUJIMATSU, Haga-gun (JP); Keiji ENDO, Haga-gun (JP); Akiko KAWASAKI, Haga-gun (JP); Tatsuya YOSHIDA, Haga-gun (JP)

(73) Assignee: KAO CORPORATION, Tokyo (JP)

(21) Appl. No.: 18/859,406

(22) PCT Filed: Apr. 27, 2023
(86) PCT No.: PCT/JP2023/016758

§ 371 Date: Oct. 23, 2024

(30) Foreign Application Priority Data
Apr. 28, 2022 (JP) 2022-075186
Nov. 1, 2022 (JP) 2022-175824

(51) Int. Cl. A01N 43/08; A01N 25/02; A01P 21/00

(52) U.S. Cl. CPC A01N 43/08; A01N 25/02; A01P 21/00

(57) ABSTRACT

Provided are a method and material for promoting the growth of leguminous plants included in beans. An agent which is a growth promoter for leguminous plants included in beans comprises ascorbic acid or a salt thereof, an antioxidant, and an organic solvent. The antioxidant is tocopherol, dibutylhydroxytoluene, butylhydroxyanisole, or a combination. The organic solvent is an alcohol having at most 5 carbon atoms and/or dimethylsulfoxide. The mass ratio of the ascorbic acid or a salt thereof to the antioxidant is from 10:1 to 3,000,000:1.

### FIELD OF THE INVENTION

The present invention relates to a method and material for promoting the growth of leguminous plants included in beans.

### BACKGROUND OF THE INVENTION

About one third of the land area on the earth belongs to the arid area, and future global warming is expected to cause a further increase in the arid area. In addition, as a countermeasure for severe food shortage due to the population increase, there is an urgent need to develop technologies to improve, maintain, and increase the yield of grains such as soybean, rice, wheat and corn in dry regions, salt-accumulated regions, hot regions, and cold regions, that is, in regions having difficulty in the growth of grains or having a lower yield due to the deteriorated growth. In particular, soybean is an important grain and is widely consumed in all over the world including Japan. Unlike other grains, soybean has a higher percentage of protein and fat, and is richer in nutritional value. Therefore, soybean is also important as a feedstuff or an oilseed material, and technologies to increase its yield are being developed.

Oxygen is essential for the survival of many animals and plants. On the other hand, oxygen generates highly reactive active oxygen in the cells of animals and plants, which can cause serious damage to the organism, such as gene damage and enzyme inactivation. Therefore, many antioxidant substances including L-ascorbic acid are stored in plant bodies, and complex enzyme systems work to use these antioxidant substances to scavenge active oxygen at various sites in the cell.

From such a viewpoint, materials to be applied to plants to promote their growth are often incorporated with antioxidants including ascorbic acid. For example, Non Patent Literature 1 discloses effects of ascorbic acid application on growth promotion and yield enhancement in olive, sugarcane, wheat, and the like. Non Patent Literature 2 discloses that a total of three foliar sprays of a certain concentration of ascorbic acid solution dissolved in distilled water to legume crops during the vegetative growth stage or reproductive growth stage can increase the yield by up to 30%. Patent Literature 1 discloses promoting the growth of plants using an aqueous composition containing an iron (II) compound and L-ascorbic acid, and Patent Literature 2 discloses promoting the growth of plants using an aqueous solution containing glycyrrhizin and L-ascorbic acid.

### CITATION LIST

### Patent Literatures

[Patent Literature 1] JP-A-S60-202805
[Patent Literature 2] JP-A-H08-143406 Non Patent Literatures
[Non Patent Literature 1] Akram et al. (2017) Ascorbic Acid-A Potential Oxidant Scavenger and Its Role in Plant Development and Abiotic Stress Tolerance. Frontiers in Plant Science, 8:613
[Non Patent Literature 2] Zarghamnejad et al., (2014) Chickpea response to ascorbic acid foliar application at vegetative and reproductive stages. International Journal of Biosciences, 5:166-170

### SUMMARY OF THE INVENTION

The present invention relates to the following 1) to 15).

1) An agent which is a growth promoter for leguminous plants included in beans and which comprises (A) ascorbic acid or a salt thereof, (B) an antioxidant, and (C) an organic solvent in combination, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

2) An agent which is a growth promoter for leguminous plants included in beans and which comprises (A) ascorbic acid or a salt thereof, (B) an antioxidant, and (C) an organic solvent in combination, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (C) the organic solvent is from 4 to 100 000 when the component (B) is 1.

3) An agent which is a nodule activity promoter and which comprises (A) ascorbic acid or a salt thereof, (B) an antioxidant, and (C) an organic solvent in combination, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

4) An agent which is a nodule activity promoter and which comprises (A) ascorbic acid or a salt thereof, (B) an antioxidant, and (C) an organic solvent in combination, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (C) the organic solvent is from 4 to 100 000 when the component (B) is 1.

5) An agent which is a yield enhancer for leguminous plants included in beans and which comprises (A) ascorbic acid or a salt thereof, (B) an antioxidant, and (C) an organic solvent in combination, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

6) An agent which is a yield enhancer for leguminous plants included in beans and which comprises (A) ascorbic acid or a salt thereof, (B) an antioxidant, and (C) an organic solvent in combination, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (C) the organic solvent is from 4 to 100 000 when the component (B) is 1.

7) A method of promoting growth of leguminous plants included in beans and which comprises a step of applying (A) ascorbic acid or a salt thereof, (B) an antioxidant, (C) an organic solvent, and water in combination to soil or plants, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

8) A method of promoting nodule activity and which comprises a step of applying (A) ascorbic acid or a salt thereof, (B) an antioxidant, (C) an organic solvent, and water in combination to soil or plants, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

9) A method of increasing yield of leguminous plants included in beans and which comprises a step of applying (A) ascorbic acid or a salt thereof, (B) an antioxidant, (C) an organic solvent, and water in combination to soil or plants, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

10) Use of a combination of (A) ascorbic acid or a salt thereof, (B) an antioxidant, and (C) an organic solvent for producing a growth promoter for leguminous plants included in beans, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

11) Use of a combination of (A) ascorbic acid or a salt thereof, (B) an antioxidant, and (C) an organic solvent for producing a growth promoter for leguminous plants included in beans, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (C) the organic solvent is from 4 to 100 000 when the component (B) is 1.

12) Use of a combination of (A) ascorbic acid or a salt thereof, (B) an antioxidant, and (C) an organic solvent for producing a nodule activity promoter, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

13) Use of a combination of (A) ascorbic acid or a salt thereof, (B) an antioxidant, and (C) an organic solvent for producing a nodule activity promoter, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (C) the organic solvent is from 4 to 100 000 when the component (B) is 1.

14) Use of a combination of (A) ascorbic acid or a salt thereof, (B) an antioxidant, and (C) an organic solvent for producing a yield enhancer for leguminous plants included in beans, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

15) Use of a combination of (A) ascorbic acid or a salt thereof, (B) an antioxidant, and (C) an organic solvent for producing a yield enhancer for leguminous plants included in beans, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (C) the organic solvent is from 4 to 100 000 when the component (B) is 1.

### BRIEF DESCRIPTION OF DRAWINGS

FIG. 1 illustrates the seed weight per individual soybean.

FIG. 2 illustrates the solubility in a varied mixing ratio of BHT and isobutyl alcohol.

FIG. 3 illustrates the solubility of mixtures of BHT and an organic solvent (1:4).

FIG. 4 illustrates the soybean nodule weight one week after foliar spray.

FIG. 5 illustrates the amount of allantoic acid contained in the soybean exudate one week after foliar spray.

FIG. 6 illustrates the amount of allantoin contained in the soybean exudate one week after foliar spray.

FIG. 7 illustrates the amount of allantoic acid contained in the soybean exudate one week after foliar spray.

FIG. 8 illustrates a soybean plant body one week after foliar spray in a test plot 7.

FIG. 9 illustrates the seed weight per individual soybean.

FIG. 10 illustrates the amount of allantoic acid contained in the soybean exudate one week after foliar spray.

FIG. 11 illustrates the azuki bean above-ground part dry weight one week after foliar spray.

FIG. 12 illustrates the azuki bean below-ground part dry weight one week after foliar spray.

FIG. 13 illustrates the chickpea above-ground part dry weight one week after foliar spray.

FIG. 14 illustrates the number of pods per individual Lotus japonicus.

FIG. 15 illustrates the seed weight per individual Lotus japonicus.

FIG. 16 illustrates the number of beans per individual broad bean.

FIG. 17 illustrates the grain weight per individual broad bean.

FIG. 18 illustrates the appearance of one-component or two-component compositions after storage for one week.

FIG. 19 illustrates the amount of allantoic acid contained in the soybean exudate one week after foliar spray.

FIG. 20 illustrates the soybean above-ground part dry weight one week after foliar spray.

FIG. 21 illustrates the soybean below-ground part dry weight one week after foliar spray.

### DETAILED DESCRIPTION OF THE INVENTION

The present invention relates to providing a method and material for promoting the growth of leguminous plants included in beans.

As a result of examining the promotion of plant growth using ascorbic acid, the present inventors found that when an ascorbic acid solution dissolved in water used in agricultural fields such as tap water or well water, is splayed to leguminous plants included in beans, almost no growth-promoting effect of ascorbic acid is obtained.

Then, the present inventors found that the combined use of ascorbic acid with a specific antioxidant dissolved in an organic solvent results in a nodule activity-promoting effect and a growth-promoting effect.

The method of the present invention can increase the amount of leguminous plants included in beans grown. Further, nodule activity is promoted in leguminous plants included in beans with root nodules formed, and the ureide formation capacity of the plants is enhanced. That is, the present invention can increase the yield of fruits, seeds, or grains of leguminous plants included in beans.

In the growth promoter for leguminous plants included in beans of the present invention, “growth promotion” means increasing the amount of leguminous plants included in beans grown (fresh weight, amount of extension, and the like), and increasing the yield of fruits, seeds, or grains. When the growth promoter for leguminous plants included in beans of the present invention is exclusively intended to increase the grain yield, this is referred to as a “yield enhancer for leguminous plants included in beans.”

In the present invention, leguminous (Fabaceae) plants included in beans are so-called “beans” whose seeds are harvested and used, such as soybean (including edamame bean), azuki bean, chickpea, Lotus japonicus, kidney bean, groundnut, broad bean, pea, scarlet runner bean, lima bean, mung bean, cowpea, black-eyed bean, hyacinth bean, sword bean, lentil, and winged bean. The leguminous plants included in beans are preferably soybean, azuki bean, kidney bean, pea, broad bean, chickpea, and Lotus japonicus, and more preferably soybean.

In the nodule activity promoter of the present invention, “nodule activity promotion” means promoting nodule activity in nodule-forming plants, that is, nitrogen fixation function exerted by nodules in the host plant.

The “nodules” refer to galls which develop on the roots of plants due to the symbiosis with bacteria (Rhizobia). Rhizobia reduce atmospheric nitrogen in the nodules, convert it into ammonia nitrogen, and supply it to the host, which is known as symbiotic nitrogen fixation.

The “nodule-forming plants” refer to host plants in which nodules are grown. In the present invention, leguminous plants included in beans are preferred.

The growth promoter or the nodule activity promoter for leguminous plants included in beans of the present invention comprises (A) ascorbic acid or a salt thereof, (B) an antioxidant, and (C) an organic solvent in combination.

(A) Ascorbic acid or a salt thereof, (B) the antioxidant and (C) the organic solvent are combined by mixing the components (A), (B), and (C) at a suitable mass ratio in advance or on use. As one aspect, the components (A), (B), and (C) are combined to form a single formulation (one-component formulation (composition)). Other aspects include a two-component formulation (kit) in which a formulation containing the component (A) and a formulation containing the components (B) and (C) are separately prepared, and they are combined on use.

In the present invention, the IUPAC systematic name of ascorbic acid as the component (A) is (R)-3,4-dihydroxy-5-((S)-1,2-dihydroxyethyl)furan-2(5H)-one. Ascorbic acid may be any of a D-form, an L-form, and a DL-form, but is preferably an L-form (so-called L-ascorbic acid).

Ascorbic acid can be any of commercial products of various grades.

Examples of salts of ascorbic acid may include salts with nitrogen-containing organic bases, such as sodium salt, potassium salt, calcium salt, magnesium salt, barium salt, ammonium salt, pyridine, trimethylamine, triethylamine, tributylamine, and diethylamine.

When the growth promoter or the nodule activity promoter for leguminous plants included in beans of the present invention is applied to a plant, the concentration of (A) ascorbic acid or a salt thereof in the composition can be appropriately adjusted, for example, in the range of 100 mass ppm or more and 300 000 mass ppm or less in accordance with the supply method.

For example, in the case of spraying using a sprayer (e.g., a boom sprayer) or the like, the concentration of (A) ascorbic acid or a salt thereof in the spraying solution is preferably 100 mass ppm or more, more preferably 300 mass ppm or more, and further more preferably 500 mass ppm or more, and is preferably 20 000 mass ppm or less, more preferably 10 000 mass ppm or less, and further more preferably 4 500 mass ppm or less. Further, the concentration of (A) ascorbic acid or a salt thereof is preferably from 100 to 20 000 mass ppm, more preferably from 300 to 10 000 mass ppm, and further more preferably from 500 to 4 500 mass ppm.

In the case of aerial spraying, the concentration of (A) ascorbic acid or a salt thereof in the spraying solution is preferably 20 000 mass ppm or more, more preferably 80 000 mass ppm or more, and further more preferably 150 000 mass ppm or more, and is preferably 300 000 mass ppm or less, more preferably 250 000 mass ppm or less, and further more preferably 200 000 mass ppm or less. Further, the concentration of (A) ascorbic acid or a salt thereof is preferably from 20 000 to 300 000 mass ppm, more preferably from 80 000 to 250 000 mass ppm, and further more preferably from 150 000 to 200 000 mass ppm.

In the present invention, the antioxidant as the component (B) is specifically at least one member selected from the group consisting of a tocopherol (vitamin E), dibutylhydroxytoluene (BHT), and butylhydroxyanisole (BHA). Preferred among these are BHT and BHA, which are phenolic antioxidants, and more preferred is BHT.

Here, in the present invention, it is also possible to use, as an antioxidant in combination, an antioxidant other than a tocopherol, BHT, and BHA, for example, at least one member selected from the group consisting of sodium erythorbate, propyl gallate, sodium sulfite, potassium sulfite, potassium pyrosulfite, chlorogenic acid, catechin, glutathione, and uric acid, and preferably sodium sulfite, potassium sulfite, potassium pyrosulfite, chlorogenic acid, catechin, glutathione, and uric acid.

Therefore, in a preferred aspect, at least one phenolic antioxidant selected from the group consisting of BHT and BHA is used as the antioxidant as the component (B), and in addition to the phenolic antioxidant, at least one member selected from the group consisting of sodium sulfite, potassium sulfite, glutathione, and uric acid is used in combination.

When ascorbic acid is dissolved in water containing metal ions, such as tap water, the metal ions reacts with ascorbic acid to form hydrogen peroxide, and the hydrogen peroxide further undergoes a Fenton reaction with the metal ions to form hydroxyl radicals. Then, the hydroxyl radicals enter the plant body and cause continuous lipid peroxidation reactions which react with lipids present in cell membranes and the like, and lipid radicals and lipid peroxy radicals are thereby formed. The use of an antioxidant makes it possible to capture such radicals.

In the present invention, due to the use of (B) the antioxidant in a solution state dissolved in (C) the organic solvent, the plant growth-promoting or nodule activity-promoting effect of ascorbic acid can be effectively exhibited.

The growth promoter or the nodule activity promoter for leguminous plants included in beans of the present invention may be either a one-component formulation or a two-component formulation, as described above, and they are each used in such a manner that a formulation containing the component (A) (first agent) and a formulation containing the components (B) and (C) (second agent) are separately prepared and combined to form a two-component formulation (kit), and both formulations are mixed on use. The form of a two-component type can suppress discoloration which occurs when a formulation containing all of the components (A), (B), and (C) is stored.

In this case, the first agent containing the component (A) may contain an antioxidant different from a tocopherol, BHT, and BHA, for example, at least one member selected from the group consisting of sodium sulfite, potassium sulfite, potassium pyrosulfite, chlorogenic acid, catechin, glutathione, and uric acid.

When the growth promoter or the nodule activity promoter for leguminous plants included in beans of the present invention is applied to a plant, the concentration of (B) the antioxidant in the composition is preferably 0.001 mass ppm or more, more preferably 0.01 mass ppm or more, and further more preferably 0.1 mass ppm or more, and is preferably 100 mass ppm or less, more preferably 20 mass ppm or less, and further more preferably 5 mass ppm or less. In addition, the concentration of (B) the antioxidant is preferably from 0.001 to 100 mass ppm, more preferably from 0.01 to 20 mass ppm, and further more preferably from 0.1 to 5 mass ppm.

Here, the organic solvent as the component (C) is a solvent which is used to dissolve (B) the antioxidant, and is specifically at least one member selected from the group consisting of an alcohol having at most 5 carbon atoms and dimethylsulfoxide (DMSO).

The alcohol having at most 5 carbon atoms is preferably ethanol, methanol, 1-propanol, 2-propanol, 1-butanol, 2-butanol, 2-methyl-2-propanol, isobutyl alcohol, 1-pentanol, 3-methyl-1-butanol, 2,2-dimethyl-1-propanol, ethylene glycol, diethylene glycol, propylene glycol, glycerol, or the like; more preferred are isobutyl alcohol and DMSO.

When at least one member selected from the group consisting of BHT and BHA is used as (B) the antioxidant, it is preferable to use DMSO, isobutyl alcohol, or a mixture thereof as (C) the organic solvent.

When the growth promoter or the nodule activity promoter for leguminous plants included in beans of the present invention is applied to a plant, the concentration of (C) the organic solvent in the composition can be appropriately adjusted in the range of 1 mass ppm or more and 100 000 mass ppm or less in accordance with the supply method.

For example, in the case of spraying using a sprayer (e.g., a boom sprayer) or the like, the concentration of (C) the organic solvent in the spraying solution is preferably 1 mass ppm or more, more preferably 10 mass ppm or more, and further more preferably 50 mass ppm or more, and is preferably 10 000 mass ppm or less, more preferably 5 000 mass ppm or less, and further more preferably 1 000 mass ppm or less. Further, the concentration of (C) the organic solvent is preferably from 1 to 10 000 mass ppm, more preferably from 10 to 5 000 mass ppm, and further more preferably from 50 to 1 000 mass ppm.

In the case of aerial spraying, the concentration of (C) the organic solvent in the spraying solution is preferably 100 mass ppm or more, more preferably 1 000 mass ppm or more, and further more preferably 5 000 mass ppm or more, and is preferably 100 000 mass ppm or less, more preferably 50 000 mass ppm or less, and further more preferably 10 000 mass ppm or less. Further, the concentration of (C) the organic solvent is preferably from 100 to 100 000 mass ppm, more preferably from 1 000 to 50 000 mass ppm, and further more preferably from 5 000 to 10 000 mass ppm.

In terms of the ratio (mass ratio) of the combination of (A) ascorbic acid or a salt thereof, (B) the antioxidant, and (C) the organic solvent, when the component (B) is 1, the component (A) is preferably 10 or more, more preferably 100 or more, and further more preferably 500 or more, and is preferably 3 000 000 or less, more preferably 2 000 000 or less, and further more preferably 200 000 or less. Further, the component (A) is preferably from 10 to 3 000 000, more preferably from 100 to 2 000 000, and further more preferably from 500 to 200 000. Of these, the component (A) is preferably from 500 to 45 000 in the case of spraying with a sprayer, and is preferably from 150 000 to 2 000 000 in the case of spraying by aerial spraying. Further, the component (A) is more preferably from 500 to 4 500 in the case of spraying with a sprayer, and is more preferably from 150 000 to 200 000 in the case of spraying by aerial spraying.

When the component (B) is 1, the component (C) is preferably 4 or more, more preferably 10 or more, further more preferably 20 or more, and further more preferably 50 or more, and is preferably 100 000 or less, more preferably 50 000 or less, further more preferably 20 000 or less, and further more preferably 10 000 or less. Further, the component (C) is preferably from 4 to 100 000, more preferably from 10 to 50 000, further more preferably from 20 to 20 000, and further more preferably from 50 to 10 000. Among these, the component (C) is preferably from 20 to 10 000 in the case of spraying with a sprayer, and is preferably from 2 000 to 100 000 in the case of spraying by aerial spraying. Further, the component (C) is more preferably from 50 to 1 000 in the case of spraying with a sprayer, and is more preferably from 5 000 to 10 000 in the case of spraying by aerial spraying.

In the present invention, (D) a surfactant can also be used in combination with (A) ascorbic acid or a salt thereof, (B) the antioxidant, and (C) the organic solvent.

Due to the use of a surfactant, the wettability, adhesion, and permeability of (A) ascorbic acid or a salt thereof to the plant surface can be improved, and the effects of (A) ascorbic acid or a salt thereof can be enhanced or efficiently exhibited.

As described above, when the growth promoter or the nodule activity promoter for leguminous plants included in beans of the present invention is formed into a two-component formulation (kit) comprising a combination of a formulation containing the component (A) (first agent) and a formulation containing the components (B) and (C) (second agent), it is preferable that (D) the surfactant is contained in the second agent containing the components (B) and (C).

As the surfactant, a nonionic surfactant and/or an anionic surfactant can be contained.

The nonionic surfactant is, for example, at least one member selected from the group consisting of a sorbitan fatty acid ester, a glycerol fatty acid ester, a polyoxyalkylene sorbitan fatty acid ester, a polyoxyethylene fatty acid ester, a polyglycerol fatty acid ester, a polyalkylene glycol fatty acid ester, a polyoxyethylene resin acid ester, a polyoxyethylene alkyl ether, a polyoxyethylene alkylaryl ether, a polyoxyalkylene aryl ether, a polyoxyethylene alkenyl ether, an alkyl polyglycoside, a polyoxyalkylene alkyl polyglycoside, and a sucrose fatty acid ester. The anionic surfactant is, for example, at least one member selected from the group consisting of alkyl sulfate, alkylbenzene sulfonate, polyoxyalkylene alkyl ether sulfate, polyoxyalkylene alkenyl ether sulfate, polyoxyalkylene alkyl aryl ether sulfate, fatty acid salts, pyrophosphate, lauryl phosphoric acid, polycarboxylic acid polymers, polyoxyethylene alkylene alkyl acetate, aromatic sulfonate formalin condensates, polyoxyethylene distyrenated ether sulfate, alkyl diphenyl ether disulfonate, dialkyl sulfosuccinate, alkyl naphthalene sulfonate, and the like.

Among these, from the viewpoint of preventing chemical damage to plants in the case of over-application, the nonionic surfactant is preferably at least one member selected from the group consisting of a sorbitan fatty acid ester, a glycerol fatty acid ester, a polyoxyalkylene sorbitan fatty acid ester, a polyalkylene glycol fatty acid ester, a polyoxyethylene resin acid ester, a polyoxyethylene alkyl ether, an alkyl polyglycoside, and a sucrose fatty acid ester; and more preferably at least one member selected from the group consisting of a sorbitan fatty acid ester, a glycerol fatty acid ester, a polyalkylene glycol fatty acid ester, a polyoxyethylene resin acid ester, and a polyoxyethylene alkyl ether. The anionic surfactant is preferably at least one member selected from the group consisting of alkyl sulfate (e.g., sodium lauryl sulfate, ammonium lauryl sulfate, or triethanolamine lauryl sulfate) and a fatty acid salt.

When the growth promoter or the nodule activity promoter for leguminous plants included in beans of the present invention is applied to a plant, the concentration of (D) the surfactant in the composition can be appropriately adjusted in the range of 10 mass ppm or more and 30 000 mass ppm or less depending on the supply method.

For example, in the case of spraying using a sprayer (e.g., a boom sprayer) or the like, the concentration of (D) the surfactant in the spraying solution is preferably 10 mass ppm or more, more preferably 100 mass ppm or more, and further more preferably 200 mass ppm or more, and is preferably 5 000 mass ppm or less, more preferably 1 000 mass ppm or less, and further more preferably 500 mass ppm or less. Further, the concentration of (D) the surfactant is preferably from 10 to 5 000 mass ppm, more preferably from 10 to 1 000 mass ppm, and further more preferably from 100 to 500 mass ppm.

Further, in the case of aerial spraying, the concentration of (D) the surfactant in the spraying solution is preferably 100 mass ppm or more, more preferably 500 mass ppm or more, and further more preferably 1 000 mass ppm or more, and is preferably 10 000 mass ppm or less, more preferably 8 000 mass ppm or less, and further more preferably 5 000 mass ppm or less. Further, the concentration of (D) the surfactant is preferably from 100 to 10 000 mass ppm, more preferably from 500 to 8 000 mass ppm, and further more preferably from 1 000 to 5 000 mass ppm.

In terms of the ratio (mass ratio) when combining (D) the surfactant, when the component (B) is 1, the component (D) is preferably 10 or more, more preferably 50 or more, and further more preferably 100 or more, and is preferably 300 000 or less, more preferably 100 000 or less, and further more preferably 5 000 or less. Further, the component (D) is preferably from 10 to 300 000, more preferably from 50 to 100 000, and further more preferably from 100 to 5 000. In this range, the component (D) is preferably from 100 to 5 000 in the case of spraying with a sprayer, and is preferably from 1 000 to 50 000 in the case of spraying by aerial spraying. Further, the component (D) is more preferably from 100 to 500 in the case of spraying with a sprayer, and is more preferably from 1 000 to 5 000 in the case of spraying by aerial spraying.

Further, in the present invention, (E) a chelating agent can be used in combination with (A) ascorbic acid or a salt thereof, (B) the antioxidant, and (C) the organic solvent.

The use of a chelating agent can improve the stability of (A) ascorbic acid or a salt thereof, and can consequently stabilize the effects of ascorbic acid or a salt thereof.

As described above, when the growth promoter or the nodule activity promoter for leguminous plants included in beans of the present invention is formed into a two-component formulation (kit) comprising a combination of a formulation containing the component (A) (first agent) and a formulation containing the components (B) and (C) (second agent), it is preferable that (E) the chelating agent is contained in the first agent containing the component (A).

Examples of chelating agents may include aminocarboxylic acid-based chelating agents, phosphonic acid-based chelating agents, hydroxycarboxylic acid-based chelating agents, polyhydric carboxylic acid-based chelating agents, and the like. Examples of aminocarboxylic acid-based chelating agents may include ethylenediaminetetraacetic acid (EDTA), nitrilotriacetic acid (NTA), hydroxyethylethylenediaminetriacetic acid (HEDTA), diethylenetriaminepentaacetic acid (DTPA), methylglycine diacetic acid (MGDA), triethylenetetraminehexaacetic acid (TTHA), glutamic acid diacetic acid (GLDA), hydroxyethyl iminodiacetic acid (HIDA), dihydroxyethylglycine (DHEG), aspartic acid diacetic acid (ASDA), ethylenediaminesuccinic acid (EDDS), and salts thereof. Examples of phosphonic acid-based chelating agents may include hydroxyethylidene diphosphonic acid (HEDP), nitrilotrismethylenephosphonic acid (NTMP), phosphonobutanetricarboxylic acid (PBTC), ethylenediaminetetramethylenephosphonic acid (EDTMP), and salts thereof.

Examples of hydroxycarboxylic acid-based chelating agents may include citric acid, malic acid, tartaric acid, gluconic acid, lactic acid, and salts thereof.

Examples of polyhydric carboxylic acid-based chelating agents may include succinic acid, oxalic acid, glutaric acid, adipic acid, fumaric acid, malonic acid, and salts thereof.

When the growth promoter or the nodule activity promoter for leguminous plants included in beans of the present invention is applied to a plant, the concentration of (E) the chelating agent in the composition is preferably 0.01 mass ppm or more, more preferably 0.1 mass ppm or more, and further more preferably 1 mass ppm or more, and is preferably 100 mass ppm or less, more preferably 50 mass ppm or less, and further more preferably 10 mass ppm or less. Further, the concentration of (E) the chelating agent is preferably from 0.01 to 100 mass ppm, more preferably from 0.1 to 50 mass ppm, and further more preferably from 1 to 10 mass ppm.

In terms of the ratio (mass ratio) when combining (E) the chelating agent, when the component (B) is 1, the component (E) is preferably 0.01 or more, more preferably 0.1 or more, and further more preferably 1 or more, and is preferably 100 or less, more preferably 50 or less, and further more preferably 10 or less. Further, the component (E) is preferably from 0.01 to 100, more preferably from 0.1 to 100, more preferably from 1 to 100, and further more preferably from 1 to 10.

Examples of the preferred combination of (B) the antioxidant, (C) the organic solvent, and (D) the surfactant, which are used together with (A) ascorbic acid, may include the following.
A combination in which the component (B) is an antioxidant containing at least one member selected from the group consisting of BHT and BHA, the component (C) is an organic solvent containing isobutyl alcohol or DMSO, and the component (D) is a surfactant containing at least one member selected from the group consisting of a sorbitan fatty acid ester, a glycerol fatty acid ester, a polyalkylene glycol fatty acid ester, a polyoxyethylene resin acid ester, and a polyoxyethylene alkyl ether, and optionally further containing alkyl sulfate.
A combination in which the component (B) is an antioxidant containing BHT, sodium sulfite, glutathione, and uric acid, the component (C) is an organic solvent containing isobutyl alcohol or DMSO, and the component (D) is a surfactant containing at least one member selected from the group consisting of a sorbitan fatty acid ester, a glycerol fatty acid ester, a polyalkylene glycol fatty acid ester, a polyoxyethylene resin acid ester, and a polyoxyethylene alkyl ether, and optionally further containing alkyl sulfate.

As shown in the examples provided later, it was shown that in the case of cultivating soybean, which is a nodule-forming plant, by sowing soybean seeds, followed by inoculation with Rhizobia, when a combination of ascorbic acid with an antioxidant such as BHT and an organic solvent was added, the nodule weight and the nodule activity were increased, and the production of ureide based on nodules was promoted, and the growth of the host plant was promoted.

Therefore, the combination of ascorbic acid with a specific antioxidant and an organic solvent can serve as a growth promoter or a nodule activity promoter for leguminous plants included in beans, can be used to promote the growth or the nodule activity of leguminous plants included in beans, and can also be used to produce the growth promoter or the nodule activity promoter for leguminous plants included in beans. Since it has been reported that the amount of ureide derived from nodules correlates with the grain yield (Total basal fertilizer nitrogen diagnosis method for rotational field soybeans, Ibaraki Prefectural Agricultural Center, Agricultural Research Institute, H18 Main results; http://www.pref.ibaraki.jp/nourinsuisan/noken/seika/h18pdf/documents/27.pdf), such a nodule activity promoter is expected to be useful to increase the grain yield.

Since the nitrogen fixation function in host plants can be evaluated as the ureide formation capacity or the amide formation capacity, the nodule activity of the present invention can be specifically evaluated as the amount of the ureide or the amide formed per the wet nodule weight. The amount of ureide or amide formed can be calculated by measuring the amount of ureide or amide in the exudate collected by cutting the plant body (e.g., cutting the above-ground part just below the cotyledons). The ureide is allantoin, allantoic acid, or citrulline, and the amide is asparagine or glutamine, and it is preferable to measure the amount of allantoic acid or asparagine.

The growth promoter or the nodule activity promoter for leguminous plants included in beans described above can serve as a composition for promoting the growth or nodule activity of leguminous plants included in beans (e.g., various agricultural or horticultural materials), or a material (simple substance) or formulation for addition or incorporation into cultivation substrates for cultivating plants, such as soil, media, and solutions for hydroponic cultivation.

The above composition may be in the form of a liquid or gel composition, or a solid composition (block, powder, granules, and the like).

The composition can be a composition obtained by mixing the components (A), (B), and (C) in advance, or a composition obtained by separately preparing a formulation containing the component (A) and a formulation containing the components (B) and (C), and mixing them on use.

The above composition may contain any components, in addition to the components (A) to (C) and further (D) and (E) used in the present invention. Examples of such components may include solvents (e.g., water, buffers, media, and solutions for hydroponic cultivation), carriers (e.g., zeolite, silica, bentonite, mirabilite, diatomaceous earth, vermiculite, perlite, peat moss, activated carbon, humus, talc, clay, carbon black, pulp, straw, soybean cake, kaolin, montmorillonite, and alumina), pH adjusters for promoting the dissolution of the above compounds, spreading agents for increasing the ability to spread to plant bodies or soil, fertilizer components for increasing fertilizer effects, agrichemical components, binders, extenders, plant growth-promoting microorganisms such as rhizobia and mycorrhizal fungi, essential nutrients for plants, flavonoids, organic acids, amino acids, peptides, nucleosides, nucleotides, nucleobases, sugars, monohydric alcohols, food additives, microorganism extracts, plant hormones, Nod factors, i.e., lipo-chitooligosaccharides, synthetic lipo-chitooligosaccharides, and chitooligosaccharides, chitinous compounds, linoleic acid or derivatives thereof, linolenic acid or derivatives thereof, karrikins, acyl-homoserine lactone derivatives, betaine compounds, phenolic compounds, and the like.

When the growth promoter or the nodule activity promoter for leguminous plants included in beans of the present invention is used as a one-component formulation, it is preferable to incorporate at least one carrier selected from the group consisting of zeolite, silica, bentonite, and mirabilite in terms of the storage stability of the formulation or the prevention of browning, and it is more preferable to incorporate silica in terms of storage stability and browning prevention. In this case, the concentration of the carrier (component (F)) in the composition is preferably 50 mass ppm or more, more preferably 100 mass ppm or more, and further more preferably 250 mass ppm or more, and is preferably 1 000 mass ppm or less, more preferably 750 mass ppm or less, and further more preferably 650 mass ppm or less. Further, the concentration of the carrier is preferably from 50 to 1 000 mass ppm, more preferably from 100 to 750 mass ppm, and further more preferably from 250 to 650 mass ppm.

In terms of the ratio (mass ratio) when combining (F) the carrier, when the component (B) is 1, the component (F) is preferably 50 or more, more preferably 100 or more, and further more preferably 250 or more, and is preferably 1 000 or less, more preferably 750 or less, and further more preferably 650 or less. Further, the component (F) is preferably from 50 to 1 000, more preferably from 100 to 750, and further more preferably from 250 to 650.

The composition for aerial spraying may contain an emulsifier such as a polyoxyethylene fatty acid ester, and an oiling agent such as decyl alcohol.

Examples of the above composition may include, but are not limited to, cultivation substrates at least containing the components (A) to (C) of the present invention (e.g., agricultural or horticultural soil, culture soil, media, solutions for hydroponic cultivation, and water), fertilizers, water for watering, microbial materials such as Rhizobium materials, soil conditioners, agricultural chemicals, sowing materials, plant supplements (e.g., activating agents and nutritional supplements), and the like.

The fertilizers, microbial materials, soil conditioners, sowing materials, and plant supplements are preferred because they contribute to the improvement of soil for cultivating plants. The fertilizers, microbial materials, soil conditioners, sowing materials, and plant supplements may be solid or liquid. In the case of solids, they may be blocks, powders, granules, or the like, but are preferably powders or granules. The fertilizers, microbial materials, soil conditioners, sowing materials, and plant supplements may contain components of fertilizers, microbial materials, soil conditioners, sowing materials, and plant supplements generally used for cultivation of plants, in addition to the components (A) to (C) as active ingredients.

The cultivation substrates, fertilizers, microbial materials such as Rhizobium materials, soil conditioners, agricultural chemicals, sowing materials, and plant supplements may be prepared by adding the components (A) to (C) of the present invention to general cultivation substrates (e.g., agricultural or horticultural soil, culture soil, media, solutions for hydroponic cultivation, and water), fertilizers, microbial materials such as Rhizobium materials, soil conditioners, agricultural chemicals, sowing materials, plant supplements (e.g., activating agents and nutritional supplements), and the like.

The composition can be one obtained by separately preparing a formulation containing the component (A) and a formulation containing the components (B) and (C), and mixing them on use. In the case of a two-component formulation in which a formulation containing the component (A) (first agent) and a formulation containing the components (B) and (C) (second agent) are mixed on use, the weight ratio of the first agent is from 1 to 100, preferably from 1 to 50, and more preferably from 1 to 25, when the second agent is 1.

When the first agent and the second agent are each prepared by dissolution in water, the concentration of the first agent in the aqueous solution is preferably 100 mass ppm or more and 300 000 mass ppm or less, and the concentration of the second agent in the aqueous solution is preferably 10 mass ppm or more and 100 000 mass ppm or less.

The method for supplying the growth promoter or the nodule activity promoter for leguminous plants included in beans of the present invention is not particularly limited as long as they are applied to plants so that the effects of the present invention can be exhibited.

That is, the method is not particularly limited as long as the above composition is brought into contact with or delivered to the plant bodies of leguminous plants included in beans or soil in the plant rhizosphere. Examples of the method may include surface spraying to the soil, irrigation, plowing-in, foliar spray to plants, application after mixing with fertilizers, addition to hydroponic solutions, coating or smearing of seeds before sowing (e.g., seed powder coating), and the like. It is preferable that the components of the present invention are applied in the form of a spraying solution diluted with water. In particular, foliar spray is preferably used.

The spraying solution may be prepared at the time of application, and the dilution water used in this case may be any of agricultural water, well water, groundwater, river water, lake water, tap water, and the like.

The method for spraying is not particularly limited, and examples thereof may include a spray method; that is, the spraying solution is dispersed in a mist by spraying. With such a method, after the growth promoter or the nodule activity promoter for leguminous plants included in beans of the present invention can be attached to plants and then spread well on the plants.

Examples of the method for spraying using a spray method may include a manual spraying method using a mister, an atomizer, a sprayer (e.g., a boom sprayer), or the like, and an aerial spraying method using an airplane, a helicopter, a drone, or the like.

The application amount of the growth promoter or the nodule activity promoter for leguminous plants included in beans of the present invention depends on the concentrations of the components (A) to (C) contained in the composition for application. For example, when the concentration of the component (A) contained in the spraying solution is from 100 to 300 000 mass ppm, the amount of the component (A) used per plant in the composition is preferably 1 mg or more, more preferably 5 mg or more, and more preferably 10 mg or more, and is preferably 150 mg or less, more preferably 100 mg or less, and more preferably 50 mg or less. Further, the amount of the component (A) is preferably from 1 to 150 mg, more preferably from 5 to 100 mg, and more preferably from 10 to 50 mg. The growth promoter or the nodule activity promoter for leguminous plants included in beans may be applied in an amount in the above range at once or in several portions.

The timing and the frequency of application vary in accordance with the type of leguminous plant included in beans and the like; for soybean, in general, in the case of application to a cultivation substrate such as soil, by surface spraying, irrigation, plowing-in or seed powder coating, it is preferably applied once or 1 to 3 times before sowing or at the same time as sowing. In the case of application after sowing, the timing is preferably from the early nutritional growth phase before the reproductive growth phase to the grain filling phase after the reproductive growth phase.

Regarding the embodiment described above, the present invention further discloses the following aspects.

<1> An agent which is a growth promoter for leguminous plants included in beans and which comprises (A) ascorbic acid or a salt thereof, (B) an antioxidant, and (C) an organic solvent in combination, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

<2> An agent which is a growth promoter for leguminous plants included in beans and which comprises (A) ascorbic acid or a salt thereof, (B) an antioxidant, and (C) an organic solvent in combination, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (C) the organic solvent is from 4 to 100 000 when the component (B) is 1.

<3> An agent which is a nodule activity promoter and which comprises (A) ascorbic acid or a salt thereof, (B) an antioxidant, and (C) an organic solvent in combination, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

<4> An agent which is a nodule activity promoter and which comprises (A) ascorbic acid or a salt thereof, (B) an antioxidant, and (C) an organic solvent in combination, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (C) the organic solvent is from 4 to 100 000 when the component (B) is 1.

<5> An agent which is a yield enhancer for leguminous plants included in beans and which comprises (A) ascorbic acid or a salt thereof, (B) an antioxidant, and (C) an organic solvent in combination, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

<6> An agent which is a yield enhancer for leguminous plants included in beans and which comprises (A) ascorbic acid or a salt thereof, (B) an antioxidant, and (C) an organic solvent in combination, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (C) the organic solvent is from 4 to 100 000 when the component (B) is 1.

<7> The agent according to any one of <1> to <6>, wherein in terms of the ratio (mass ratio) of (A) ascorbic acid or a salt thereof and (C) the organic solvent, when the component (B) is 1, the component (A) is from 10 to 3 000 000, preferably from 100 to 2 000 000, and more preferably from 500 to 200 000, and the component (C) is from 4 to 100 000, preferably from 10 to 50 000, more preferably from 20 to 20 000, and further more preferably from 50 to 10 000.

<8> The agent according to any one of <1> to <7>, wherein (B) the antioxidant further contains at least one member selected from the group consisting of sodium sulfite, potassium sulfite, glutathione, and uric acid.

<9> The agent according to any one of <1> to <8>, wherein (C) the organic solvent is at least one member selected from the group consisting of isobutyl alcohol and dimethylsulfoxide.

<10> The agent according to any one of <1> to <9>, which further contains (D) a surfactant in combination.

<11> The agent according to <10>, wherein the ratio (mass ratio) of (D) the surfactant is preferably from 10 to 300 000, more preferably from 50 to 100 000, and further more preferably from 100 to 5 000, when the component (B) is 1.

<12> The agent according to <10> or <11>, wherein (D) the surfactant contains a nonionic surfactant and/or an anionic surfactant.

<13> The agent according to <12>, wherein in terms of (D), the nonionic surfactant is at least one member selected from the group consisting of a sorbitan fatty acid ester, a glycerol fatty acid ester, a polyalkylene glycol fatty acid ester, and a polyoxyethylene alkyl ether, and the anionic surfactant is an alkyl sulfate salt.

<14> The agent according to <12>, wherein (D) the surfactant contains a nonionic surfactant and an anionic surfactant.

<15> The agent according to <14>, wherein in terms of (D), the nonionic surfactant is at least one member selected from the group consisting of a sorbitan fatty acid ester, a glycerol fatty acid ester, a polyalkylene glycol fatty acid ester, a polyoxyethylene resin acid ester, and a polyoxyethylene alkyl ether, and the anionic surfactant is at least one member selected from the group consisting of an alkyl sulfate salt and a fatty acid salt.

<16> The agent according to any one of <1> to <15>, which further contains (E) a chelating agent in combination.

<17> The agent according to <16>, wherein in terms of the ratio (mass ratio) of (A) ascorbic acid or a salt thereof, (C) the organic solvent, (D) the surfactant, and (E) the chelating agent, when the component (B) is 1, the component (A) is from 10 to 3 000 000, preferably from 100 to 2 000 000, and more preferably from 500 to 200 000, the component (C) is from 4 to 100 000, preferably from 10 to 50 000, more preferably from 20 to 20 000, and further more preferably from 50 to 10 000, the component (D) is preferably from 10 to 300 000, more preferably from 50 to 100 000, and further more preferably from 100 to 5 000, and the component (E) is preferably from 0.01 to 100, more preferably from 0.1 to 100, more preferably from 1 to 100, and further more preferably from 1 to 10.

<18> The agent according to <16> or <17>, wherein (E) the chelating agent is at least one member selected from the group consisting of ethylenediaminetetraacetic acid and ethylenediamine-N,N′-disuccinic acid.

<19> The agent according to any one of <1> to <18>, which further contains (F) a carrier in combination.

<20> The agent according to <19>, wherein the ratio (mass ratio) of (F) the carrier is from 10 to 10 000, preferably from 50 to 1 000, more preferably from 100 to 750, and further more preferably from 250 to 650, when the component (B) is 1.

<21> The agent according to <19> or <20>, wherein (F) the carrier is at least one member selected from the group consisting of zeolite, silica, bentonite, and mirabilite.

<22> The agent according to any one of <1> to <9>, which comprises a first agent comprising the component (A) and a second agent comprising the components (B) and (C), wherein both are combined on use.

<23> A method of promoting growth of leguminous plants included in beans and which comprises a step of applying (A) ascorbic acid or a salt thereof, (B) an antioxidant, (C) an organic solvent, and water in combination to soil or plants, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

<24> A method of promoting nodule activity and which comprises a step of applying (A) ascorbic acid or a salt thereof, (B) an antioxidant, (C) an organic solvent, and water in combination to soil or plants, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

<25> A method of increasing yield of leguminous plants included in beans and which comprises a step of applying (A) ascorbic acid or a salt thereof, (B) an antioxidant, (C) an organic solvent, and water in combination to soil or plants, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

<26> The method according to any one of <23> to <25>, wherein a first agent comprising the component (A) and a second agent comprising the components (B) and (C) are prepared, and both are combined on use and applied to soil or plants.

<27> The agent according to <22>, wherein the weight ratio of the first agent is from 1 to 100, when the second agent is 1.

<28> The method according to <26>, wherein the first agent and the second agent are dissolved in water for use.

<29> The method according to <28>, wherein the concentration of the first agent in an aqueous solution is 100 mass ppm or more and 300 000 mass ppm or less, and the concentration of the second agent is 10 mass ppm or more and 100 000 mass ppm or less.

<30> Use of a combination of (A) ascorbic acid or a salt thereof, (B) an antioxidant, and (C) an organic solvent for producing a growth promoter for leguminous plants included in beans, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

<31> Use of a combination of (A) ascorbic acid or a salt thereof, (B) an antioxidant, and (C) an organic solvent for producing a growth promoter for leguminous plants included in beans, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (C) the organic solvent is from 4 to 100 000 when the component (B) is 1.

<32> Use of a combination of (A) ascorbic acid or a salt thereof, (B) an antioxidant, and (C) an organic solvent for producing a nodule activity promoter, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

<33> Use of a combination of (A) ascorbic acid or a salt thereof, (B) an antioxidant, and (C) an organic solvent for producing a nodule activity promoter, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (C) the organic solvent is from 4 to 100 000 when the component (B) is 1.

<34> Use of a combination of (A) ascorbic acid or a salt thereof, (B) an antioxidant, and (C) an organic solvent for producing a yield enhancer for leguminous plants included in beans, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (A) ascorbic acid or a salt thereof is from 10 to 3 000 000 when the component (B) is 1.

<35> Use of a combination of (A) ascorbic acid or a salt thereof, (B) an antioxidant, and (C) an organic solvent for producing a yield enhancer for leguminous plants included in beans, wherein (B) the antioxidant is at least one member selected from the group consisting of a tocopherol, dibutylhydroxytoluene, and butylhydroxyanisole, (C) the organic solvent is at least one member selected from the group consisting of an alcohol having at most 5 carbon atoms and dimethylsulfoxide, and the ratio (mass ratio) of (C) the organic solvent is from 4 to 100 000 when the component (B) is 1.

<36> The use according to any one of <30> to <35>, wherein in terms of the ratio (mass ratio) of (A) ascorbic acid or a salt thereof and (C) the organic solvent, when the component (B) is 1, the component (A) is from 10 to 3 000 000, preferably from 100 to 2 000 000, and more preferably from 500 to 200 000, and the component (C) is from 4 to 100 000, preferably from 10 to 50 000, more preferably from 20 to 20 000, and further more preferably from 50 to 10 000.

<37> The use according to any one of <30> to <36>, wherein (B) the antioxidant further contains at least one member selected from the group consisting of sodium sulfite, potassium sulfite, glutathione, and uric acid.

<38> The use according to any one of <30> to <37>, wherein (C) the organic solvent is at least one member selected from the group consisting of isobutyl alcohol and dimethylsulfoxide.

<39> The use according to any one of <30> to <38>, which further contains (D) a surfactant in combination.

<40> The use according to <39>, wherein the ratio (mass ratio) of (D) the surfactant is preferably from 10 to 300 000, more preferably from 50 to 100 000, and further more preferably from 100 to 5 000, when the component (B) is 1.

<41> The use according to <39> or <40>, wherein (D) the surfactant contains at least a nonionic surfactant or an anionic surfactant.

<42> The use according to <41>, wherein (D) the surfactant contains an anionic surfactant in addition to a nonionic surfactant.

<43> The use according to <42>, wherein in terms of (D), the nonionic surfactant is at least one member selected from the group consisting of a sorbitan fatty acid ester, a glycerol fatty acid ester, a polyalkylene glycol fatty acid ester, a polyoxyethylene resin acid ester, and a polyoxyethylene alkyl ether, and the anionic surfactant is at least one member selected from the group consisting of an alkyl sulfate salt and a fatty acid salt.

<44> The use according to any one of <30> to <43>, which further contains (E) a chelating agent in combination.

<45> The use according to <44>, wherein in terms of the ratio (mass ratio) of (A) ascorbic acid or a salt thereof, (C) the organic solvent, (D) the surfactant, and (E) the chelating agent, when the component (B) is 1, the component (A) is from 10 to 3 000 000, preferably from 100 to 2 000 000, and more preferably from 500 to 200 000, the component (C) is from 4 to 100 000, preferably from 10 to 50 000, more preferably from 20 to 20 000, and further more preferably from 50 to 10 000, the component (D) is preferably from 10 to 300 000, more preferably from 50 to 100 000, and further more preferably from 100 to 5 000, and the component (E) is preferably from 0.01 to 100, more preferably from 0.1 to 100, more preferably from 1 to 100, and further more preferably from 1 to 10.

<46> The use according to <44> or <45>, wherein (E) the chelating agent is at least one member selected from the group consisting of ethylenediaminetetraacetic acid and ethylenediamine-N,N′-disuccinic acid.

<47> The use according to any one of <30> to <38>, which comprises a first agent comprising the component (A) and a second agent comprising the components (B) and (C), wherein both are combined on use.

<48> In <1>, <2>, <5>, <6>, <23>, <25>, <30>, <31>, <34>, and <35>, the leguminous plants included in beans are preferably beans selected from the group consisting of soybean, azuki bean, chickpea, Lotus japonicus, kidney bean, groundnut, broad bean, pea, scarlet runner bean, lima bean, mung bean, cowpea, hyacinth bean, and sword bean; more preferably beans selected from the group consisting of soybean, azuki bean, kidney bean, pea, broad bean, chickpea, and Lotus japonicus; and more preferably soybean.

### EXAMPLES

### Test Example 1: Influence of Ascorbic Acid Dissolved in Water on Application Effect

An ascorbic acid aqueous solution prepared by dissolving ascorbic acid in water and an ascorbic acid aqueous solution prepared by dissolving ascorbic acid in deionized water were prepared, and the influence of the ascorbic acid dissolved in water on the application effect for soybean (Glycine max) was examined.

The influence of one foliar spray of 500 mass ppm ascorbic acid on the soybean yield was evaluated. The evaluated test plots 1 to 3 are as shown below.
1 plot: control (no application)
2 plot: foliar spray of 500 mass ppm ascorbic acid (dissolved in tap water)
3 plot: foliar spray of 500 mass ppm ascorbic acid (dissolved in deionized water)

### (1) Cultivation Conditions

The cultivation of soybean was carried out in a field in Tochigi Prefecture, and the soybean cultivar used was “Sato no Hohoemi.” Of the field, a ridge with a width of 2 m excluding the perimeter was used as one plot, and foliar spray treatment was carried out. 12 plots per test plot were tested in the control (test plot 1) and three plots per test plot were tested in the ascorbic acid application plots (test plots 2 and 3). An average of 19 plants were cultivated in the range of 2 m, which was set as one plot.

### (2) Foliar Spray Treatment and Grain Weight Measurement

The ascorbic acid used was “Food Additive Grade Vitamin C (L-ascorbic acid) Fine Mesh TypeSSS” manufactured by Fuso Chemical Co. Ltd. An aqueous solution of 500 mass ppm ascorbic acid was dissolved in tap water or deionized water for production. Using a battery-driven atomizer (GT-5HS, Koshin Ltd.), 20 mL of the ascorbic acid aqueous solution per plant was sprayed over the entire soybean plant body. Spraying was carried out on day 60 after sowing, and the growth stage corresponded to the grain filling phase. The plants were harvested on day 108 after sowing. All grains were collected from each plant after harvest, and dried at 100° C. for 48 hours. The dry grain mass was measured as yield data.

### (3) Results

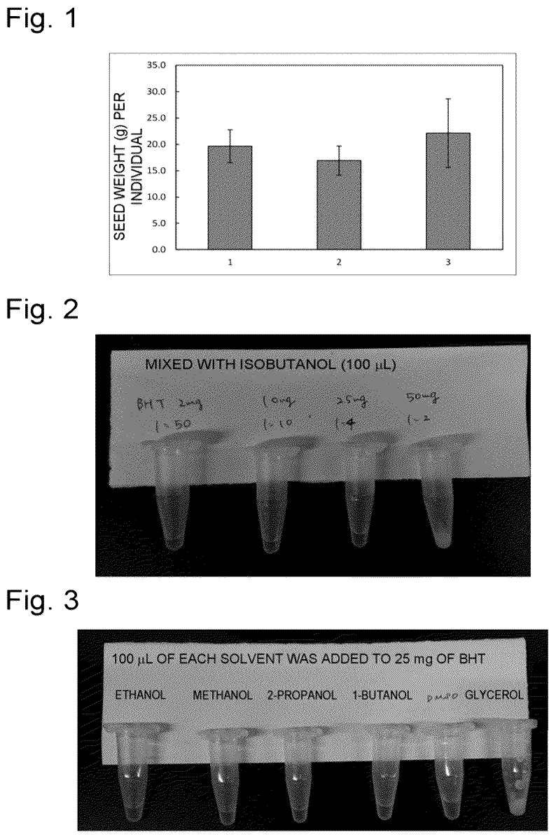

After calculating the average grain weight of each plant in one plot, the mean and the standard deviation of three plots were calculated (FIG. 1). The graph of each figure shows mean±standard deviation. It was indicated that when the same concentration of ascorbic acid is foliar sprayed, tap water and deionized water have different effects on the seed weight. That is, the issue in which the effects of ascorbic acid disappear with the water used in agricultural fields (tap water) has been found.

### Test Example 2: Solubility of Dibutylhydroxytoluene in Various Solvents

The amount of BHT dissolved in 100 μL of isobutyl alcohol was changed. It was confirmed that BHT was uniformly dissolved in an amount up to 25 mg, i.e., up to a ratio of BHT:isobutyl alcohol=1:4 (FIG. 2). For other solvents, solubility was similarly confirmed at a ratio of BHT:solvent=1:4. Of the solvents examined, BHT was uniformly dissolved in ethanol, methanol, 2-propanol, 1-butanol, and dimethylsulfoxide (DMSO), except for glycerol (FIG. 3). BHT is known to be poorly soluble in water. The reagents used were those manufactured by FUJIFILM Wako Pure Chemical Corporation.

### Example 1: Preparation of Spraying Solution Having Plant Growth-Promoting and Nodule Activity-Promoting Effects and Yield-Enhancing Effect

### (1) Preparation of Two-Component Composition

By using the following components, the two-component compositions shown in Table 1 were prepared. After at least one member selected from the group consisting of BHT, BHA, and a tocopherol as the component (B) was previously dissolved in the component (C), the component (D) was further mixed to prepare a second agent. Next, at least one member selected from the group consisting of the components (A) and (E) was mixed to prepare a first agent. The composition examples shown in Table 2 were prepared as two-component compositions in which the amounts of the components (A), (B), (C), (D), and (E) incorporated were as shown in the table.

### (2) Preparation of Spraying Solution and Solubility Evaluation

The prepared two-component composition was dissolved in 100 mL of tap water heated to 30° C. to evaluate the solubility of the spraying solution. That is, after the second agent was dissolved in heated tap water, the first agent was further dissolved, and its solubility was evaluated.

### (3) Reagents Used

The ascorbic acid used was “Food Additive Grade Vitamin C (L-ascorbic acid) Fine Mesh TypeSSS” manufactured by Fuso Chemical Co. Ltd. The sodium ascorbate, tocopherol, BHT, BHA, ethanol, methanol, 2-propanol, isobutyl alcohol, 1-butanol, DMSO, and citric acid used were those manufactured by FUJIFILM Wako Pure Chemical Corporation. The EDTA used was one manufactured by Dojindo Laboratories. The surfactants used were sorbitan monolaurate, polyoxyethylene sorbitan monooleate, polyoxyethylene sorbitan monolaurate, polyoxyethylene lauryl ether, polyoxyethylene alkyl ether, and polyethylene glycol monolaurate.

### (4) Solubility Evaluation Results

Regarding the aqueous solution solubility of the spraying solutions prepared using each composition, the appearance was evaluated using the following criteria. The results are shown in Table 2.

Good: The aqueous solution was uniform with no undissolved residue.
Fair: The aqueous solution became uniform immediately after stirring, although a part of the spraying solution remained undissolved.
Poor: The aqueous solution did not become uniform even immediately after stirring, with part of the spraying solution remaining undissolved.

The results of Table 2 indicated that uniform spraying solutions suitable for spraying as plant growth promoters were obtained in Composition Examples 1 to 17.

TABLE 1

| | First agent | Second agent |
|---|---|---|
| Component | Component (A) | Component (B), Component (C) |
| | Component (E) | Component (D) |

TABLE 2

| | | | | | | | Solubility |
|---|---|---|---|---|---|---|---|
| | | | | | | | evaluation |
| | | First agent | | Second agent | | | in tap |
| | | Component (A) | Component (E) | Component (B) | Component (C) | Component (D) | water |
| Composition | 1 | Ascorbic acid 50 mg | | BHT 0.1 mg | Isobutyl alcohol 5 mg | | Good |
| Example | 2 | Ascorbic acid 20 g | | BHT 0.1 mg | Isobutyl alcohol 5 mg | | Good |
| | 3 | Ascorbic acid 150 mg | | BHT 0.1 mg | Isobutyl alcohol 1,000 mg | | Good |
| | 4 | Ascorbic acid 150 mg | | BHT 0.1 mg | Isobutyl alcohol 5 mg | | Good |
| | 5 | Ascorbic acid 30 g | | BHT 0.01 mg | Isobutyl alcohol 0.04 mg | | Good |
| | 6 | Ascorbic acid 10 mg | | BHT 0.1 mg | Isobutyl alcohol 4 mg | | Good |
| | 7 | Ascorbic acid 10 mg | | BHT 0.1 mg | Ethanol 10,000 mg | | Good |
| | 8 | Ascorbic acid 150 mg | | BHT 0.1 mg | Isobutyl alcohol 5 mg | Sorbitan | Good |
| | | | | | | monolaurate 10 mg | |
| | 9 | Ascorbic acid 150 mg | | BHT 0.1 mg | Isobutyl alcohol 5 mg | Sorbitan | Good |
| | | | | | | monolaurate 500 mg | |
| | 10 | Ascorbic acid 150 mg | | BHT 0.01 mg | DMSO 5 mg | Polyethylene glycol | Good |
| | | | | | | monolaurate 0.1 mg | |
| | 11 | Ascorbic acid 150 mg | | BHT 0.01 mg | DMSO 5 mg | Polyethylene glycol | Good |
| | | | | | | monolaurate 3,000 mg | |
| | 12 | Ascorbic acid 30 g | | BHT 0.01 mg | DMSO 1,000 mg | Polyethylene glycol | Good |
| | | | | | | monolaurate 3,000 mg | |
| | 13 | Ascorbic acid 150 mg | | BHT 0.1 mg | 2-Propanol 10 mg | Polyoxyethylene sorbitan | Good |
| | | | | | | monooleate 25 mg | |
| | 14 | Ascorbic acid 150 mg | | BHT 1 mg | DMSO 50 mg | Polyoxyethylene | Good |
| | | | | | | lauryl ether 300 mg | |
| | 15 | Sodium | | BHA 0.1 mg | 1-Butanol 5 mg | Polyoxyethylene | Good |
| | | ascorbate 150 mg | | | | alkyl ether 35 mg | |
| | 16 | Ascorbic acid 30 g | Citric | Tocopherol 10 mg | Methanol 10,000 mg | Polyoxyethylene sorbitan | Good |
| | | | acid 10 mg | | | monolaurate 3,000 mg | |
| | 17 | Ascorbic acid 150 mg | EDTA 0.1 mg | BHT 0.1 mg | Ethanol 5 mg | Sorbitan | Good |
| | | | | | | monolaurate 35 mg | |
| | 18 | Ascorbic acid 40 g | | BHT 0.1 mg | Isobutyl alcohol 5 mg | | Poor |

### Example 2: Evaluation of Nodule Weight and Nodule Activity

### (1) Preparation of Soil and Sowing

Medium-term fertilizer effect type culture soil (Takii hydrous cell medium-term fertilizer effect type, Takii & Co., Ltd.) and vermiculite grains (Akagi-Engei Co., Ltd.) were mixed at a volume ratio of 1:1, and the soil was placed in a polypot (diameter: 10.5 cm, height: 9 cm). The soybean seeds used were “Enrei” (purchased from Nikko Seed Co. Ltd.). After tap water was supplied in an amount of 250 mL per pot, 2 seeds per pot were each sown at a depth of from about 1 to 2 cm from the soil surface. The number of repeats in each test plot was 6 (n=6).

### (2) Inoculation of Rhizobium

1.5% agar (Wako Pure Chemical Industries, Ltd.) was added to Yeast-Mannitol (YM) medium (0.5 g of K₂HPO₄, 0.2 g of MgSO₄-7H₂O, 0.1 g of NaCl, 0.4 g of yeast extract, 10 g of mannitol, and 1 L of distilled water (pH: 6.8)) to prepare a solid medium, and a soybean Rhizobium (Bradyrhizobium japonicum) NBRC14783T strain was grown on the solid medium. A platinum loop of the grown Rhizobium was taken and inoculated in 50 mL of YM liquid medium in a Sakaguchi flask with a volume of 500 mL, and shake-cultured at 30° C. for about 36 hours. A Rhizobium culture solution whose value of turbidity OD600 of bacterial cells was about 0.3 was prepared. After sowing, 1 mL of the Rhizobium culture solution was inoculated dropwise on the seeds using a micropipettor.

### (3) Cultivation Conditions

The cultivation from sowing to thinning was carried out in an artificial weather apparatus (LPH-411SP, Nippon Medical & Chemical Instruments Co., Ltd.), and the light conditions were a light period (light intensity from 440 to 480 mol/m²/s) of 16 hours/a dark period of 8 hours, a temperature of 30° C. for the light period/25° C. for the dark period, and a humidity of 50%. On day 7 after sowing, the plants were thinned so as to be one plant per pot. After thinning, the cultivation was carried out outdoor. Watering was carried out by adding water to a vat placed under the pot so that about 5 cm of the lower part of the pot was submerged after the vat had run out of water.

### (4) Foliar Spray Treatment

The spraying solutions shown in Table 3 were prepared, and 6.7 mL of each was sprayed per plant using a mister on day 14 after sowing. Foliar spray was carried out only once, and 7 types of test plots were examined.

For the preparation of the spraying solutions, BHT of the component (B) was previously dissolved in DMSO of the component (C), and the components (C) and (D) were then mixed to prepare a second agent. Next, the component (A), uric acid (antioxidant), and the component (E) were mixed to prepare a first agent. After the second agent was dissolved in the water used, the first agent was further dissolved, thereby preparing a spraying solution.

The ascorbic acid used herein was “Food Additive Grade Vitamin C (L-ascorbic acid) Fine Mesh TypeSSS” manufactured by Fuso Chemical Co. Ltd. BHT, uric acid, DMSO, and EDTA used were those manufactured by FUJIFILM Wako Pure Chemical Corporation, and EDDS used was “Chelest EDDS-35” manufactured by Chelest Co., Ltd. As the component (C), DMSO and isobutanol were used. As the nonionic surfactant of the component (D), sorbitan monolaurate, or a sorbitan fatty acid ester and a polyoxyethylene resin acid ester were used. Further, as the anionic surfactant of the component (D), a fatty acid soap potassium salt was used.

TABLE 3

| | | Spraying solution | | | | | |
|---|---|---|---|---|---|---|---|
| | | Component (A) | Component (B) | Component (C) | Component (D) | Component (E) | Water used |
| Test plot | 1 | | | | | | No spraying |
| | 2 | Ascorbic acid | | | | | Delonized |
| | | 1,500 ppm | | | | | water |
| | 3 | Ascorbic acid | | | | | Tap water |
| | | 1,500 ppm | | | | | |
| | 4 | Ascorbic acid | BHT 1 ppm + | DMSO 50 ppm | Sorbitan | EDTA | Tap water |
| | | 1,500 ppm | uric acid 100 | | monolaurate | 5 ppm | |
| | | | ppm | | 350 ppm | | |
| | 5 | Ascorbic acid | BHT 1 ppm + | | Sorbitan | EDTA | Tap water |
| | | 1,500 ppm | uric acid 100 | | monolaurate | 5 ppm | |
| | | | ppm | | 350 ppm | | |
| | 6 | Ascorbic acid | BHT 1 ppm + | DMSO 50 ppm + | Sorbitan fatty acid ester 350 ppm + | EDTA | |
| | | 1,500 ppm | uric acid 100 | isobutanol 50 ppm | polyoxylene resin acid ester 28 ppm + fatty | 5 ppm | Tap water |
| | | | ppm | | acid soap potassium salt 7 ppm | | |
| | 7 | Ascorbic acid | BHT 1 ppm + | DMSO 50 ppm + | Sorbitan fatty acid ester 350 ppm + | EDDS | Tap water |
| | | 1,500 ppm | uric acid 100 | Isobutanol 50 ppm | polyoxylene resin acid ester 28 ppm + fatty | 5 ppm | |
| | | | ppm | | acid soap potassium salt 7 ppm | | |

(5) Exudate Collection Method for Measuring the Amount of Ureide Nitrogen, which Serves as an Indicator of Nodule Activity

21 days of cultivation later, soybean stems were cut at the cotyledonary node using pruning shears, and covered with a 1.5 mL microtube (Eppendorf) filled with Cotton Balls #10 (Kawamoto Corporation), and the exudate exuding from the cut surface of the stem was collected for 2 hours. After collecting the exudate, the cotton balls were stored in a freezer at −80° C. Further, the weight of the cotton balls was compared before and after the collection of the exudate to thereby calculate the amount of the exudate.

### (6) Extract Operation of Exudate Components Collected in Cotton Balls

Exudate components contained in the cotton balls were eluted with ultrapure water and filtered using Micro Biospin chromatography column (Bio-Rad Laboratories, Inc.). The filtrate remaining in the column was centrifuged and collected by driving a centrifuge (CR15RN, Hitachi, Ltd.) at 15 000 rpm for 1 minute. The 1 000-fold diluted filtrate was quantified.

### (7) Equipment and Measurement Method Used for Quantification of the Amount of Ureide Nitrogen

The HPLC equipment and the mass spectrometer used were Agilent 1260 Infinity LC System (Agilent Technologies Japan, Ltd.) and AB SCIEX Triple Quad 4500 System (AB Sciex Pte. Ltd.), respectively. The column used was Scherzo SS-C18 (100 mm×2 mm, 3 μm) (Imtakt Corporation), and the oven temperature was 40° C. 5 μL of an appropriately diluted sample was injected at a flow rate of 0.5 mL/min, and the eluents used were a 0.1% formic acid aqueous solution (eluent A) and a 50 mM ammonium acetate/methanol solution (eluent B). After equilibration with eluent A:eluent B=95:5, the sample was supplied, and 5 minutes later, ureide nitrogen was eluted by linear gradient so that eluent A:eluent B=80:20.

### (8) Standard Products Used and Quantification

The amount of ureide nitrogen in the exudate was analyzed by LC-MS. The standard products used were allantoin (Tokyo Chemical Industry Co., Ltd.) and allantoic acid (Toronto Research Chemicals Inc.). The standard products were analyzed by LC-MS, and a calibration curve was created in the range from 10 to 1 000 ppb.

For each sample, allantoin and allantoic acid were identified from the retention time, the exact mass and MS/MS spectral agreement with each reagent. Further, allantoin and allantoic acid in the sample were quantified from the calibration curve, and the total amount per plant was determined.

### (9) Results

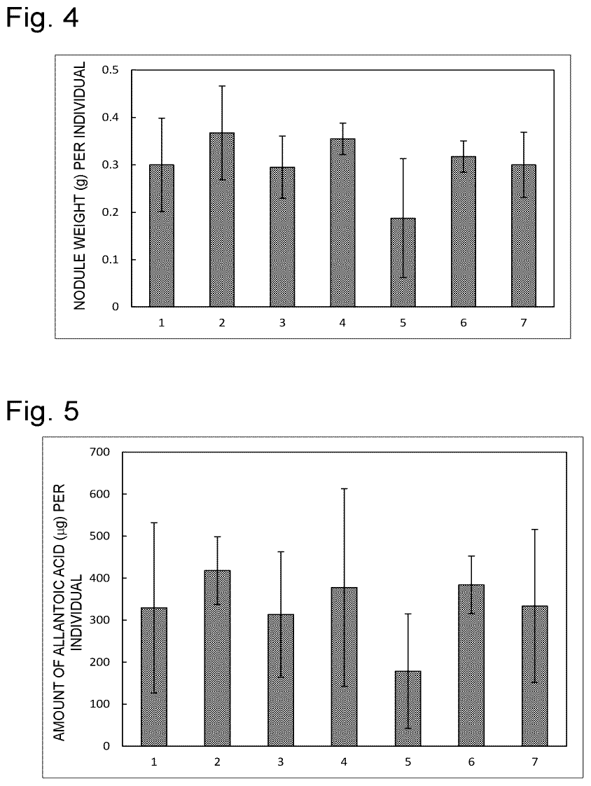

The measurement results of the nodule weight and the nodule activity are shown in FIGS. 4 and 5. The mean and the standard deviation were calculated from the data of four repeats, excluding the highest and the lowest values from the six repeats in each test plot. The graph of each figure shows mean±standard deviation.

Test Example 1 indicated that the difference in water quality for dissolving ascorbic acid affected the soybean yield. From the test plots 1 to 3 in this example, it was confirmed that the nodule weight and the nodule activity increased at the soybean early growth stage when ascorbic acid was dissolved in deionized water, and that the application effect of ascorbic acid tended to decrease when ascorbic acid was dissolved in tap water. A comparison between the test plots 4 and 5 indicated that the addition of an organic solvent was necessary to recover nodule activity which was reduced by dissolving ascorbic acid in tap water. Moreover, a comparison between the test plots 6 and 7 suggested that EDTA was more preferred as the chelating agent for the recovery of the nodule activity.

### Example 3: Consideration of the Mixing Ratio of Ascorbic Acid and Antioxidant

The items of the preparation of soil and sowing, the inoculation of Rhizobium, the exudate collection method for measuring the amount of ureide nitrogen, which serves as an indicator of nodule activity, the experimental operation before quantification of exudate, the equipment and measurement method used for quantification of the amount of ureide nitrogen, and the standard products used and quantification were the same as those in Example 2, and the cultivation of soybean was carried out for 21 days.

### (1) Cultivation Conditions

The cultivation was carried out in an artificial weather apparatus (LPH-411SP, Nippon Medical & Chemical Instruments Co., Ltd.), with the light condition of a light period (light intensity from 440 to 480 mol/m²/s) of 16 hours/a dark period of 8 hours, the temperature of 30° C. for the light period/25° C. for the dark period, and a humidity of 50%. On day 7 after sowing, the plants were thinned so as to be one plant per pot. Watering was carried out by adding water to a vat placed under the pot so that about 5 cm of the lower part of the pot would be submerged after the vat had run out of water.

### (2) Foliar Spray Treatment

The spraying solutions shown in Table 4 below were prepared in the same manner as in Example 2, and 6.7 mL of each was sprayed per plant using a mister an day 14 after sowing. Foliar spray was carried out only once, and 7 types of test plots were examined (Table 4). The amount of water to be sprayed was constant, and the amount of ascorbic acid per plant was changed to adjust the concentration of ascorbic acid in the spraying solution. The reagents used were the same as those in Example 2.

TABLE 4

| | | Spraying solution | | | | |
|---|---|---|---|---|---|---|
| | | Component (A) | Component (B) | Component (C) | Component (D) | Water used |
| Test plot | 1 | | | | | No spraying |
| | 2 | Ascorbic acid | | | | Tap water |
| | | 1,500 ppm | | | | |
| | 3 | | BHT 1 ppm | Isobutyl | Sorbitan | Tap water |
| | | | | alcohol | monolaurate | |
| | | | | 50 ppm | 350 ppm | |
| | 4 | Ascorbic acid | BHT 1 ppm | Isobutyl | Sorbitan | Tap water |
| | | 500 ppm | | alcohol | monolaurate | |
| | | | | 50 ppm | 350 ppm | |
| | 5 | Ascorbic acid | BHT 1 ppm | Isobutyl | Sorbitan | Tap water |
| | | 1,500 ppm | | alcohol | monolaurate | |
| | | | | 50 ppm | 350 ppm | |
| | 6 | Ascorbic acid | BHT 1 ppm | Isobutyl | Sorbitan | Tap water |
| | | 4,500 ppm | | alcohol | monolaurate | |
| | | | | 50 ppm | 350 ppm | |
| | 7 | Ascorbic acid | BHT 1 ppm | Isobutyl | Sorbitan | Tap water |
| | | 20,000 ppm | | alcohol | monolaurate | |
| | | | | 50 ppm | 350 ppm | |

### (3) Results

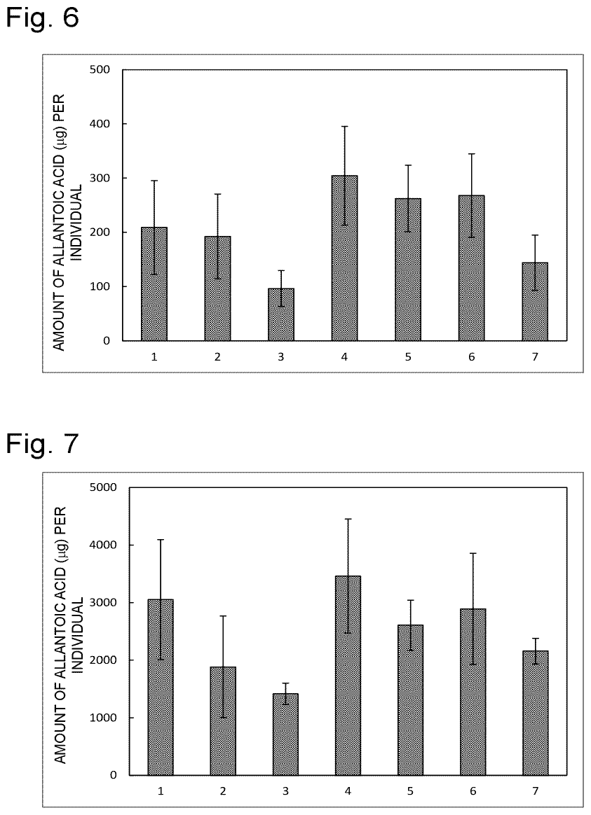

The measurement results of the nodule activity are shown in FIGS. 6 and 7. The graph of each figure shows mean±standard deviation.

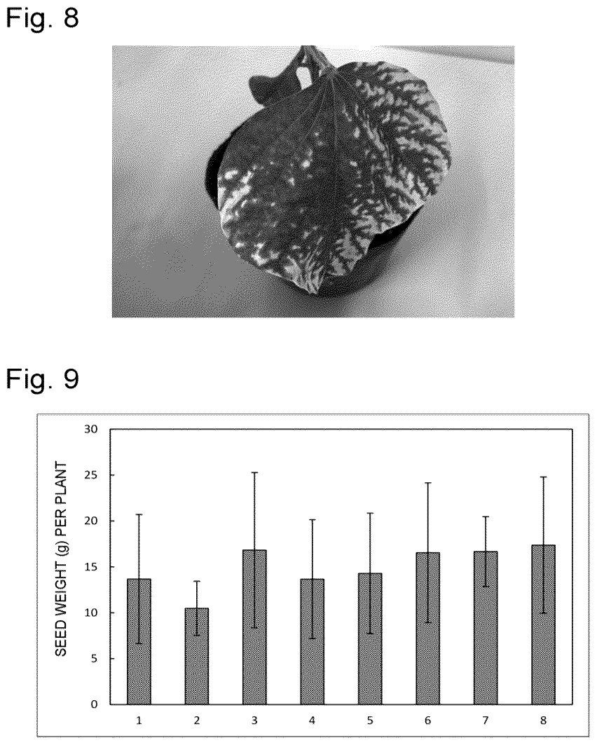

In FIGS. 6 and 7, during foliar spray of ascorbic acid dissolved in tap water, the nodule activity did not change or rather decreased in comparison to the case of no application. In the test plot 3, which is an ascorbic acid-free composition, the nodule activity was reduced; the nodule activity was recovered or improved by adding ascorbic acid to the composition of the test plot 3. In the test with the amount of water assumed for spraying using a sprayer (e.g., a boom sprayer), the highest nodule activity was observed in the test plot 4 (ascorbic acid:BHT=500:1), while the nodule activity tended to decrease in the test plot 7 (ascorbic acid:BHT=20 000:1). Further, when ascorbic acid:BHT=20 000:1, disorder in which leaves lost color occurred, as shown in FIG. 8, indicating that the mixing ratio of ascorbic acid, the component (B), and the component (C) was preferably 100 to 20 000:1:2 to 100. It was also indicated that the use of isobutyl alcohol as the component (C) also resulted in a nodule activity recovery effect.

### Example 4: Soybean Yield-Enhancing Effect in Field

The influence of foliar spray of a composition containing 1 500 ppm ascorbic acid on soybean yield was evaluated. Foliar spray was carried out only once, and types of test plots were examined (Table 5).

TABLE 5

| | | Spraying solution | | | | | | |
|---|---|---|---|---|---|---|---|---|
| | | | | | | | The other | |
| | | Component (A) | Component (B) | Component (C) | Component (D) | Component (E) | components | Water used |
| Test plot | 1 | | | | | | | No spraying |
| | 2 | | | | | | Urea 8 ppm + | |
| | | | | | | | potassium | Tap water |
| | | | | | | | dihydrogen | |
| | | | | | | | phosphate 8 ppm | |
| | 3 | Ascorbic acid | | | | | | Deionized |
| | | 1,500 ppm | | | | | | water |
| | 4 | Ascorbic acid | | | | | | Tap water |
| | | 1,500 ppm | | | | | | |
| | 5 | Ascorbic acid | BHT 1 ppm + | Isobutyl | Sorbitan | EDTA 5 ppm | | Tap water |
| | | 1,500 ppm | uric acid 100 ppm + | alcohol | monolaurate | | | |
| | | | glutathione 100 ppm + | 50 ppm | 350 ppm | | | |
| | | | sodium sulfite 1 ppm | | | | | |
| | 6 | Ascorbic acid | BHT 1 ppm | Isobutyl | Sorbitan | | | Tap water |
| | | 1,500 ppm | | alcohol | monolaurate | | | |
| | | | | 50 ppm | 350 ppm | | | |
| | 7 | Ascorbic acid | BHT 1 ppm + | Isobutyl | Sorbitan | | | |
| | | 1,500 ppm | uric acid 100 ppm + | alcohol | monolaurate | | | |
| | | | glutathione 100 ppm + | 50 ppm | 350 ppm | EDTA 5 ppm | Urea 8 ppm + | Tap water |
| | | | sodium sulfite 1 ppm | | | | potassium | |
| | | | | | | | dihydrogen | |
| | | | | | | | phosphate 8 ppm | |
| | 8 | Ascorbic acid | BHT 1 ppm + | Isobutyl | Polyoxyethylene | EDTA 5 ppm | | Tap water |
| | | 1,500 ppm | uric acid 100 ppm + | alcohol | lauryl ether | | | |
| | | | glutathione 100 ppm + | 50 ppm | 350 ppm | | | |
| | | | sodium sulfite 1 ppm | | | | | |

### (1) Cultivation Conditions

The cultivation of soybean was carried out in a field in Tochigi Prefecture, and the soybean cultivar used was “Sato no Hohoemi.” Of the field, a ridge with a width of 2 m excluding the perimeter was used as one plot, and foliar spray treatment was carried out. 3 plot tests were carried out per test plot. An average of 10 plants were cultivated in the range of 2 m, which was set as one plot.

### (2) Foliar Spray Treatment and Grain Weight Measurement

In addition to the reagents mentioned in Example 2, polyoxyethylene lauryl ether was used as a nonionic surfactant. Further, the urea, potassium dihydrogen phosphate, sodium sulfite, glutathione, and EDTA used were those manufactured by FUJIFILM Wako Pure Chemical Corporation.

The reagents were dissolved in tap water or deionized water to prepare spraying solutions. By using a battery-driven atomizer (GT-5HS, Koshin Ltd.), 6.7 mL of the ascorbic acid aqueous solution per plant was sprayed over the entire soybean plant body. Spraying was carried out on day 75 after sowing, and the growth stage corresponded to the grain filling phase. The plants were harvested on day 173. All grains were collected from each plant after harvest, and dried at 100° C. for 48 hours. The dry grain mass was measured as yield data.

### (3) Results

After calculating the average grain weight of each plant in one plot, the mean and the standard deviation for the eight plots were calculated (FIG. 9). The graph of each figure shows mean±standard deviation.

It was confirmed again that the effects of tap water and deionized water on seed weight were different from each other when the same concentration of ascorbic acid was foliar sprayed. It was indicated that the addition of the components (B), (C), and (D) to ascorbic acid resulted in a yield-enhancing effect even when tap water was used. It was also indicated that the use of polyoxyethylene lauryl ether as the component (D) also resulted in a yield-enhancing effect.

### Example 5: Evaluation of Nodule Activity after Application of High Concentration of Ascorbic Acid

The items of the preparation of soil and sowing, the inoculation of Rhizobium, the cultivation conditions, the exudate collection method for measuring the amount of ureide nitrogen as an indicator of nodule activity, the experimental operation before quantification of exudate, the equipment and measurement method used for quantification of the amount of ureide nitrogen, and the standard products used and quantification were the same as those in Example 3, and the cultivation of soybean was carried out for 21 days.

### (1) Foliar Spray Treatment

Foliar spray treatment was carried out on day 14 after sowing. In addition to the reagents mentioned in Examples 2, 3, and 4, polyethylene glycol monolaurate and a glycerol fatty acid ester were used as nonionic surfactants. The reagents were dissolved in tap water or deionized water to prepare spraying solutions. Foliar spray was carried out only once. Assuming aerial spraying, 8 types of test plots containing a high concentration of ascorbic acid were examined (Table 6). In the test plots 2 and 3, 6.7 mL of each per plant was sprayed using a mister, and in the test plots 4 to 8, 0.125 mL of each per plant was sprayed.

TABLE 6

| | | Spraying solution | | | | |
|---|---|---|---|---|---|---|
| | | Component (A) | Component (B) | Component (C) | Component (D) | Water used |
| Test plot | 1 | | | | | No spraying |
| | 2 | Ascorbic acid | | | | Tap water |
| | | 1,500 ppm | | | | |
| | 3 | Ascorbic acid | | | | Deionized |
| | | 1,500 ppm | | | | water |
| | 4 | Ascorbic acid | | | | Tap water |
| | | 150,000 ppm | | | | |
| | 5 | Ascorbic acid | | | | Deionized |
| | | 150,000 ppm | | | | water |
| | 6 | Ascorbic acid | BHT | DMSO | Polyethylene glycol monolaurate 2,400 ppm | |
| | | 150,000 ppm | 1 ppm | 8,000 ppm | glycerol fatty acid ester 5,500 ppm | |
| | 7 | Ascorbic acid | BHT | DMSO | Polyethylene glycol monolaurate 2,400 ppm | Tap water |
| | | 300,000 ppm | 1 ppm | 8,000 ppm | glycerol fatty acid ester 5,500 ppm | |
| | 8 | Ascorbic acid | BHT | Isobutyl alcohol | Polyethylene glycol monolaurate 2,400 ppm | Tap water |
| | | 150,000 ppm | 1 ppm | 8,000 ppm | glycerol fatty acid ester 5,500 ppm | |

### (2) Results

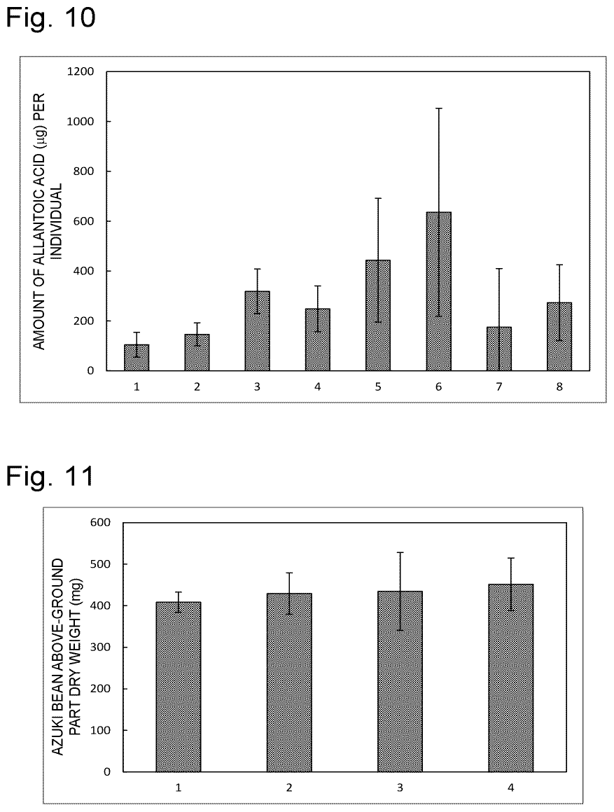

The measurement results of the nodule activity are shown in FIG. 10. The mean and the standard deviation were calculated from the data of four repeats, excluding the highest and the lowest values from the six repeats in each test plot. The graph of each figure shows mean±standard deviation.

In FIG. 10, in the test plots 4 and 5 in which ascorbic acid was sprayed with a small amount of water, the nodule activity of soybean tended to increase in comparison to the test plots 2 and 3. Regardless of the amount of water used for spraying, when deionized water was used to dissolve ascorbic acid, the nodule activity increased in comparison to when tap water was used. A comparison between the test plots 5 and 6 indicated that when BHT as the compound (B), DMSO as the compound (C), and polyethylene glycol monolaurate as the compound (D) were added to ascorbic acid, the nodule activity was highest. In contrast, in the test plot 7, when the ascorbic acid concentration was increased to 300 000 ppm, the nodule activity was reduced in comparison to the test plot 6, indicating that in the case of spraying with a small amount of water, the ascorbic acid concentration is preferably 300 000 ppm or less. Further, a comparison between the test plots 8 and 6 indicated that DMSO was more preferred than isobutyl alcohol as the compound (C). Further, it was indicated that the use of polyethylene glycol monolaurate as the compound (D) also resulted in a nodule activity recovery effect.

### Example 6: Evaluation of Initial Growth Index in Azuki Bean

### (1) Preparation of Soil and Sowing

Medium-term fertilizer effect type culture soil (Takii hydrous cell medium-term fertilizer effect type, Takii & Co., Ltd.) and vermiculite grains (Akagi-Engei Co., Ltd.) were mixed at a volume ratio of 1:1, and the soil was placed in a polypot (diameter: 10.5 cm, height: 9 cm). The azuki bean seeds used were “Tamba Dainagon Azuki Beans” (purchased from Takii & Co., Ltd.). After tap water was supplied in an amount of 250 mL per pot, 2 seeds per pot were each sown at a depth of from about 1 to 2 cm from the soil surface. The number of repeats in each test plot was 6 (n=6).

### (2) Inoculation of Rhizobium

1.5% agar (Wako Pure Chemical Industries, Ltd.) was added to Yeast-Mannitol (YM) medium (0.5 g of K₂HPO₄, 0.2 g of MgSO₄-7H₂O, 0.1 g of NaCl, 0.4 g of yeast extract, 10 g of mannitol, and 1 L of distilled water (pH: 6.8)) to prepare a solid medium, and a soybean Rhizobium (Bradyrhizobium japonicum) NBRC14783T strain was grown on the solid medium. A platinum loop of the grown Rhizobium was taken and inoculated in 50 mL of YM liquid medium in a Sakaguchi flask with a volume of 500 mL, and shake-cultured at 30° C. for about 36 hours. A Rhizobium culture solution whose value of turbidity OD600 of bacterial cells was about 0.3 was prepared. After sowing, 1 mL of the Rhizobium culture solution was inoculated dropwise on the seeds using a micropipettor.

### (3) Cultivation Conditions

The cultivation was carried out in an artificial weather apparatus (LPH-411SP, Nippon Medical & Chemical Instruments Co., Ltd.), with the light condition of a light period (light intensity from 440 to 480 mol/m²/s) of 16 hours/a dark period of 8 hours, a temperature of 25° C. for the light period/20° C. for the dark period, and a humidity of 50%. On day 7 after sowing, the plants were thinned so as to be one plant per pot. Watering was carried out by adding water to a vat placed under the pot so that about 5 cm of the lower part of the pot was submerged after the vat had run out of water.

### (4) Foliar Spray Treatment

Spraying solutions were prepared, and 6.7 mL of each per plant was sprayed only once using a mister on day 21 after sowing. For the preparation of the spraying solutions, BHT was dissolved in isobutyl alcohol and the isobutyl alcohol and sorbitan monolaurate were mixed, which was then dissolved in water. Thereafter, ascorbic acid was dissolved in the water for preparation. The reagents used were the same as those in Example 2. The evaluated test plots 1 to 4 are as follows.

On day 28 after sowing, the plant body was dried at 90° C. for 24 hours, and the above-ground part dry weight and below-ground part dry weight of the plant body were then measured.
1 plot: control (no application)
2 plot: foliar spray of 1 500 mass ppm ascorbic acid (dissolved in tap water)
3 plot: foliar spray of 1 500 mass ppm ascorbic acid (dissolved in deionized water)
4 plot: foliar spray of 1 500 mass ppm ascorbic acid+1 mass ppm BHT+50 mass ppm isobutyl alcohol+350 mass ppm sorbitan monolaurate (dissolved in tap water)

### (5) Results

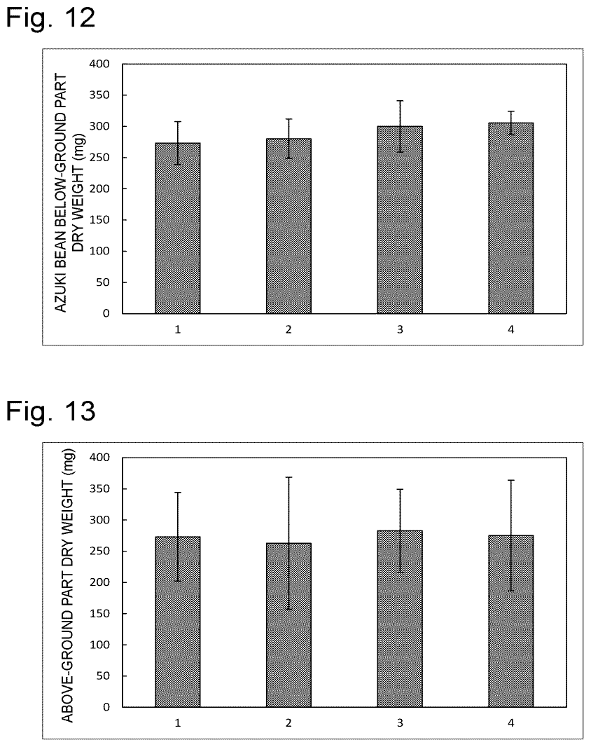

The measurement results of the above-ground part dry weight and below-ground part dry weight are shown in FIGS. 11 and 12. The graph of each figure shows mean±standard deviation.

Test Example 1 and Example 2 indicate that when the same concentration of ascorbic acid is foliar sprayed to soybean, tap water and deionized water have different effects on the seed weight and initial growth index. For azuki bean, it was also indicated that the effects on the initial growth index varied in accordance with the water quality for dissolving ascorbic acid, as with soybean. A comparison between the test plots 2 and 4 indicated that the addition of the components (B), (C), and (D) to ascorbic acid resulted in a growth-promoting effect even when tap water was used.

### Example 7: Evaluation of Initial Growth Index in Chickpea

### (1) Preparation of Soil and Sowing

Medium-term fertilizer effect type culture soil (Takii hydrous cell medium-term fertilizer effect type, Takii & Co., Ltd.) and vermiculite grains (Akagi-Engei Co., Ltd.) were mixed at a volume ratio of 1:1, and the soil was placed in a polypot (diameter: 10.5 cm, height: 9 cm). The chickpea used was seeds of Kabuli species (purchased from Nikko Seed Co. Ltd.). After tap water was supplied in an amount of 250 mL per pot, 2 seeds per pot were each sown at a depth of from about 1 to 2 cm from the soil surface. The number of repeats in each test plot was 6 (n=6).

### (2) Inoculation of Rhizobium

1.5% agar (Wako Pure Chemical Industries, Ltd.) was added to Yeast-Mannitol (YM) medium (0.5 g of K₂HPO₄, 0.2 a of MgSO₄-7H₂O, 0.1 g of NaCl, 0.4 g of yeast extract, 10 g of mannitol, and 1 L of distilled water (pH: 6.8)) to prepare a solid medium, and a chickpea Rhizobium (Mesorhizobium ciceri) NBRC100389T strain was grown on the solid medium. A platinum loop of the grown Rhizobium was taken and inoculated in 50 mL of YM liquid medium in a Sakaguchi flask with a volume of 500 mL, and shake-cultured at 30° C. for about 36 hours. A Rhizobium culture solution whose value of turbidity OD600 of bacterial cells was about 0.3 was prepared. After sowing, 1 mL of the Rhizobium culture solution was inoculated dropwise on the seeds using a micropipettor.

### (3) Foliar Spray Treatment

The cultivation conditions and the foliar spray treatment method were the same as those in Example 6 (example of azuki bean). The evaluated test plots 1 to 4 are as follows.

On day 28 after sowing, the plant body was dried at 90° C. for 24 hours, and the above-ground part dry weight of the plant body was then measured.
1 plot: control (no application)
2 plot: foliar spray of 1 500 mass ppm ascorbic acid (dissolved in tap water)
3 plot: foliar spray of 1 500 mass ppm ascorbic acid (dissolved in deionized water)
4 plot: foliar spray of 1 500 mass ppm ascorbic acid+1 mass ppm BHT+50 mass ppm isobutyl alcohol+350 mass ppm sorbitan monolaurate (dissolved in tap water)

### (4) Results

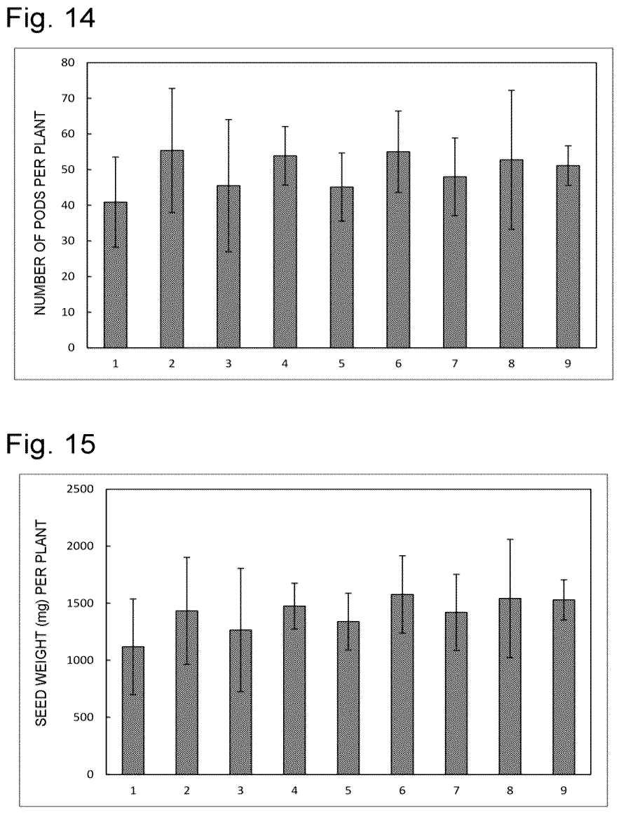

The measurement results of the above-ground part dry weight are shown in FIG. 13. The mean and the standard deviation were calculated from the data of four repeats, excluding the highest and the lowest values from the six repeats in each test plot. The graph of each figure shows mean±standard deviation.

Test Example 1 and Example 2 indicate that when the same concentration of ascorbic acid is foliar sprayed to soybean, tap water and deionized water have different effects on the seed weight and initial growth index. For chickpea, it was also indicated that the effects on the initial growth index varied in accordance with the water quality for dissolving ascorbic acid, as with soybean. A comparison between the test plots 2 and 4 indicated that the addition of the components (B), (C), and (D) to ascorbic acid resulted in a growth-promoting effect even when tap water was used.

### Example 8: Evaluation of Grain Weight in Lotus Japonicus

### (1) Preparation of Soil

Medium-term fertilizer effect type culture soil (Takii hydrous cell medium-term fertilizer effect type, Takii & Co., Ltd.) and vermiculite grains (Akagi-Engei Co., Ltd.) were mixed at a volume ratio of 1:1, and the soil was placed in a polypot (diameter: 6 cm, height: 5.5 cm).

### (2) Germination Treatment and Sowing

The Lotus japonicus seeds used were Miyakojima MG-20 lineage. To a 2 mL microtube (Eppendorf) filled approximately ⅓ with the seeds, 1 mL of concentrated sulfuric acid (FUJIFILM Wako Pure Chemical Corporation) was added and allowed to stand for 10 minutes. After rinsing five times with tap water, the seeds were soaked for two hours. After tap water was supplied in an amount of 100 mL per pot, 3 seeds, which had undergone germination treatment, per pot were each sown at a depth of from about 1 to 2 cm from the soil surface. The number of repeats in each test plot was 8 (n=8).

### (3) Inoculation of Rhizobium

1.5% agar (Wako Pure Chemical Industries, Ltd.) was added to Yeast-Mannitol (YM) medium (0.5 g of K₂HPO₄, 0.2 g of MgSO₄-7H₂O, 0.1 g of NaCl, 0.4 g of yeast extract, 10 g of mannitol, and 1 L of distilled water (pH: 6.8)) to prepare a solid medium, and a Lotus japonicus rhizobium (Mesorhizobium loti) MAFF303099 (ML GUS) strain was grown on the solid medium. A platinum loop of the grown Rhizobium was taken and inoculated in 50 mL of YM liquid medium in a Sakaguchi flask with a volume of 500 mL, and shake-cultured at 30° C. for about 36 hours. A Rhizobium culture solution whose value of turbidity OD600 of bacterial cells was about 0.3 was prepared. After sowing, 1 mL of the Rhizobium culture solution was inoculated dropwise on the seeds using a micropipettor.

### (4) Cultivation Conditions

The cultivation was carried out indoor, and the cultivation conditions included a light period of 16 hours, 25° C., an LED light source (OHGETS Co. Ltd.; model number: VGL-1200W), and a light intensity from 400 to 440 mol/m²/s. 10 days after sowing, the plants were thinned so as to be one plant per pot. Watering was carried out by adding water to a vat placed under the pot so that about 5 cm of the lower part of the pot was submerged after the vat had run out of water. 3 weeks after sowing, a 1 000-fold dilution of high-grade flowering promoter (Hyponex Japan Corp., Ltd.) was added once a week to the watering water.

### (5) Foliar Spray Treatment

The spraying solutions shown in Table 7 were prepared, and 6 weeks after sowing, 6.7 mL of each per plant in the test plots 2 to 6 and 0.125 mL of each per plant in the test plots 7 to 9 were sprayed only once using a mister. The spraying solutions shown in Table 13 were prepared, and 6.7 mL of each was sprayed per plant using a mister on day 14 after sowing. Foliar spray was carried out only once, and 7 types of test plots were examined.

For the preparation of the spraying solutions, BHT of the component (B) was previously dissolved in the component (C), and the components (C) and (D) were then mixed to prepare a second agent. Next, the component (A) and the other components were mixed to prepare a first agent. After the second agent was dissolved in the water used, the first agent was further dissolved, thereby preparing a spraying solution. Mature grains were sequentially harvested, and the cultivation was terminated 16 weeks after sowing. The number of pods and seed weight of each plant were measured.

TABLE 7

| | | Spraying solution | | | | | |
|---|---|---|---|---|---|---|---|
| | | Component (A) | Component (B) | Component (C) | Component (D) | The other components | Water used |
| Test plot | 1 | | | | | | No spraying |
| | 2 | Ascorbic acid | | | | | |
| | | 1,500 ppm | | | | | Deionized water |
| | 3 | Ascorbic acid | | | | | Tap water |
| | | 1,500 ppm | | | | | |
| | 4 | Ascorbic acid | BHT | Isobutyl | Sorbitan | | Tap water |
| | | 1,500 ppm | 1 ppm | alcohol | monolaurate | | |
| | | | | 50 ppm | 350 ppm | | |
| | 5 | Ascorbic acid | BHT | Isobutyl | Sorbitan | Potassium dihydrogen | Tap water |
| | | 1,500 ppm | 1 ppm | alcohol | monolaurate | phosphate 88 ppm | |
| | | | | 50 ppm | 350 ppm | | |
| | 6 | Ascorbic acid | BHT | Isobutyl | Sorbitan | Potassium dihydrogen | Tap water |
| | | 750 ppm | 0.5 ppm | alcohol | monolaurate | phosphate 44 ppm | |
| | | | | 25 ppm | 175 ppm | | |
| | 7 | Ascorbic acid | | | | | Deionized |
| | | 150,000 ppm | | | | | water |
| | 8 | Ascorbic acid | BHT | DMSO | Polyethylene glycol | | Tap water |
| | | 150,000 ppm | 1 ppm | 8,000 ppm | monolaurate 2,400 ppm | | |
| | | | | | glycerol fatty acid ester | | |
| | | | | | 5,500 ppm | | |
| | 9 | Ascorbic acid | BHT | DMSO | Polyethylene glycol | | Tap water |
| | | 300,000 ppm | 1 ppm | 8,000 ppm | monolaurate 2,400 ppm | | |
| | | | | | glycerol fatty acid ester | | |
| | | | | | 5,500 ppm | | |

### (6) Results

The measurement results of the number of pods are shown in FIG. 14, and the measurement results of the seed weight are shown in FIG. 15. The graph of each figure shows mean±standard deviation.

Test Example 1 and Example 2 indicated that when the same concentration of ascorbic acid was foliar sprayed to soybean, tap water and deionized water have different effects on the seed weight. For Lotus japonicus, it was also indicated that the effects on the seed weight varied in accordance with the water quality for dissolving ascorbic acid, as with soybean. A comparison between the test plots 3 and 4 indicated that the addition of the components (B), (C), and (D) to ascorbic acid increased the number of pods and seed weight even when tap water was used. The test plot 5 indicated that the addition of fertilizer components to the composition also resulted in a yield-enhancing effect. Further, as shown in the test plot 6, a sufficient application effect was obtained even when the concentration of the composition was halved.

Example 5 indicates that the nodule activity in early growth is improved when a highly concentrated composition is applied to soybean. For Lotus japonicus, as with soybean, it was also indicated that the addition of the components (B), (C), and (D) to ascorbic acid resulted in a yield-enhancing effect even when spraying was carried out with a high concentration and small amount of tap water.

### Example 9: Evaluation of Grain Weight in Broad Bean

### (1) Preparation of Soil and Cultivation Conditions

Planters (width: 65.3 cm, depth: 24.5 cm, height: 18.5 cm) were each filled with 2 L of pot bottom stone and then filled with 9 L of medium-term fertilizer effect type culture soil (Takii hydrous cell medium-term fertilizer effect type, Takii & Co., Ltd.). After 2 L of tap water per planter was supplied, 3 broad bean seedlings (variety: Nintoku Issun, Takii & Co., Ltd.) purchased at a home center were transplanted in each planter. The number of repeats in each test plot was 3 (n=3). The cultivation was carried out outdoor.

### (2) Foliar Spray Treatment

Spraying solutions were prepared, and 6.7 mL of each was sprayed per plant using a mister on day 51 after planting the seedlings. Foliar spray was carried out only once, and 4 types of test plots were examined.

For the preparation of the spraying solutions, BHT of the component (B) was previously dissolved in the component (C), and the components (C) and (D) were then mixed to prepare a second agent. Next, the component (A) and other components were mixed to prepare a first agent. After the second agent was dissolved in the water used, the first agent was further dissolved, thereby preparing a spraying solution. The reagents are the same as those in Example 1. The evaluated test plots 1 to 4 are as follows.

Mature grains were sequentially harvested, and the cultivation was terminated 96 days after planting. The number of beans and grain weight of each plant were measured.
1 plot: control (no application)
2 plot: foliar spray of 1 500 mass ppm ascorbic acid (dissolved in deionized water)
3 plot: foliar spray of 1 500 mass ppm ascorbic acid (dissolved in tap water)
4 plot: foliar spray of 1 500 mass ppm ascorbic acid+1 mass ppm BHT+50 mass ppm isobutyl alcohol+350 mass ppm sorbitan monolaurate (dissolved in tap water)

### (3) Results

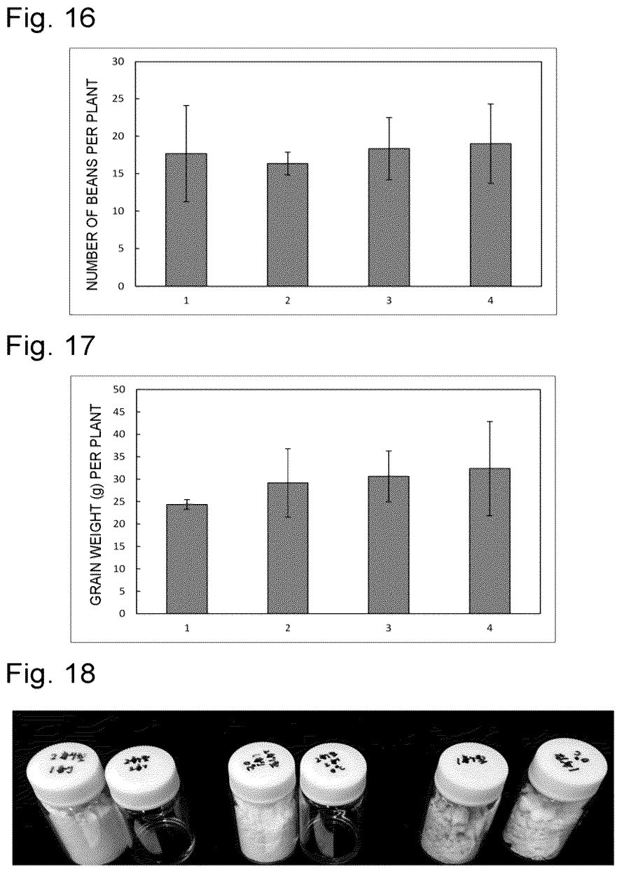

The measurement results of the number of beans per plant are shown in FIG. 16, and the measurement results of the seed weight are shown in FIG. 17. The graph of each figure shows mean±standard deviation. A comparison between the test plots 1 and 4 indicated that the addition of the components (B), (C), and (D) to ascorbic acid increased the number of beans per plant by 7.5% and the grain weight by 32.9%, and resulted in a yield-enhancing effect for broad bean as well. Further, a comparison between the test plots 3 and 4 indicated that the addition of the components (B), (C), and (D) to ascorbic acid increased the yield-enhancing effect.

### Example 10: Storage Stability Test of Composition Having Plant Growth-Promoting and Nodule Activity-Promoting Effects and Yield-Enhancing Effect

### (1) Preparation of One-Component or Two-Component Composition

Using 20 g of ascorbic acid as the component (A), 13.3 mg of BHT as the component (B), 0.67 mL of isobutyl alcohol as the component (C), and 4.7 mL of sorbitan monolaurate as the component (D), a one-component or two-component composition was produced in the following manner. After the component (B) was dissolved in the component (C), the component (D) was further mixed, and the resulting mixture was mixed with the component (A) to produce a one-component composition. A two-component composition was produced in the following manner. After the component (B) was previously dissolved in the component (C), the component (D) was further mixed to prepare a second agent. Next, only the component (A) was used as a first agent. The reagents are the same as those in Example 1.

### (2) Storage Stability Test

Half of the produced one-component or two-component composition was dispensed into two transparent glass bottles. The bottles were stored in a refrigerator with a set temperature of 4° C. or a storehouse with a set temperature of 50° C. for one week. After one week, the appearance of the formulations and the aqueous solution solubility when the formulations after storage were 500-fold diluted with water were evaluated.

### (3) Results of Formulation Appearance and Solubility Evaluation

The evaluation results of the appearance of the formulations are shown in FIG. 18. The left of the photograph shows the first and the second agents after storage of the two-component composition at 50° C., the center of the photograph shows the first and the second agents after storage of the two-component composition at 4° C., and the right of the photograph shows the one-component composition after storage at 50° C. and the one-component composition after storage at 4° C.

From the results of FIG. 18, in the two-component compositions, no difference was observed in appearance between the sample stored at 4° C. and the sample stored at 50° C. In contrast, in the one-component compositions, the color of the appearance varied in accordance with the storage temperature. Further, it was indicated that uniform spraying solutions suitable for spraying as plant growth promoters were obtained from both the one-component type and the two-component type. The examination results suggested that the one-component type discolored significantly during storage, and that the two-component type was superior in terms of appearance.

### Example 11: Examination of Mixing Ratio of Organic Solvent

The items of the preparation of soil and sowing, the inoculation of Rhizobium, the exudate collection method for measuring the amount of ureide nitrogen, which serves as an indicator of nodule activity, the experimental operation before quantification of exudate, the equipment and measurement method used for quantification of the amount of ureide nitrogen, and the standard products used and quantification were the same as those in Example 2, and the cultivation of soybean was carried out for 21 days.

### (1) Cultivation Conditions

The cultivation was carried out in an artificial weather apparatus (LPH-411SP, Nippon Medical & Chemical Instruments Co., Ltd.), with the light condition of a light period (light intensity from 440 to 480 mol/m²/s) of 16 hours/a dark period of 8 hours, a temperature of 30° C. for the light period/25° C. for the dark period, and a humidity of 50%. On day 7 after sowing, the plants were, thinned so as to be one plant per pot. Watering was carried out by adding water to a vat placed under the pot so that about 5 cm of the lower part of the pot would be submerged after the vat had run out water.

### (2) Foliar Spray Treatment

The spraying solutions shown in Table 0 were prepared. On day 14 after sowing, 6.7 M of each per plant in the test plots 1 to 5 and 0.125 mL of each par plant in the test plots 6 to 8 were sprayed only once using a mister. Foliar spray was carried out only once, and 7 types of test plots were examined (Table 0). The reagents used were the same as those in Example 5.

TABLE 8

| Spraying solution | | | | | |
|---|---|---|---|---|---|
| Compound (A) | Compound (B) | Compound (C) | Compound (D) | Compound (E) | |
| compound and | compound and | compound and | compound and | compound and | |
| concentration | concentration | concentration | concentration | concentration | Water used |

| | | | | | | |
|---|---|---|---|---|---|---|
| Test plot | 1 | | | | | Tap water |
| of Example | 2 | Ascorbic acid | | | | Tap water |
| | | 1,500 ppm | | | | |
| | 3 | Ascorbic acid | BHT | Isobutanol | Sorbitan monolaurate | Tap water |
| | | 1,500 ppm | 1 ppm | 10 ppm | 350 ppm | |
| | 4 | Ascorbic acid | BHT | Isobutanol | Sorbitan monolaurate | Tap water |
| | | 1,500 ppm | 1 ppm | 100 ppm | 350 ppm | |
| | 5 | Ascorbic acid | BHT | Isobutanol | Sorbitan monolaurate | Tap water |
| | | 1,500 ppm | 1 ppm | 500 ppm | 350 ppm | |
| | 6 | Ascorbic acid | BHT | DMSO | Polyethylene glycol | Tap water |
| | | 150,000 ppm | 1 ppm | 1,000 ppm | monolaurate 2,400 ppm | |
| | | | | | glycerol fatty acid ester | |
| | | | | | 5,500 ppm | |
| | 7 | Ascorbic acid | BHT | DMSO | Polyethylene glycol | Tap water |
| | | 150,000 ppm | 1 ppm | 5,000 ppm | monolaurate 2,400 ppm | |
| | | | | | glycerol fatty acid ester | |
| | | | | | 5,500 ppm | |
| | 8 | Ascorbic acid | BHT | DMSO | Polyethylene glycol | Tap water |
| | | 150,000 ppm | 1 ppm | 10,000 ppm | monolaurate 2,400 ppm | |
| | | | | | glycerol fatty acid ester | |
| | | | | | 5,500 ppm | |

### (3) Results

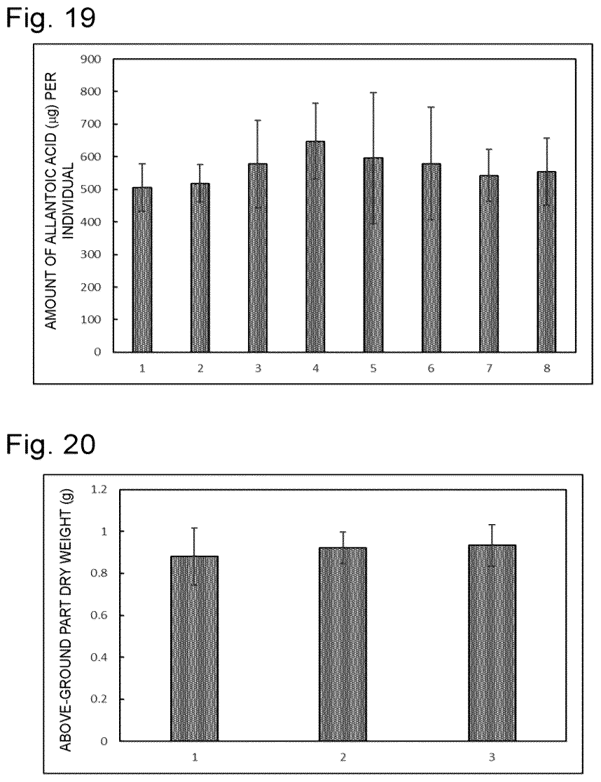

The measurement results of the nodule activity are shown in FIG. 19. The graph of each figure shows mean±standard deviation.

A comparison between the test plots 2 and 3 to 8 indicated that the addition of the components (B), (C), and (D) to ascorbic acid resulted in a higher nodule activity-improving effect than when ascorbic acid was applied alone using tap water for dissolution. It was also indicated that the effect was exhibited even when the mixing ratio of the components (B) and (C) was 1:10 to 10 000.

### Example 12: Evaluation of Initial Growth Index at Low Concentration of Antioxidant

The preparation of soil and sowing and the inoculation of Rhizobium were the same as those in Example 2, and the cultivation of soybean was carried out for 21 days.

### (1) Cultivation Conditions

The cultivation was carried out in an artificial weather apparatus (LPH-411SP, Nippon Medical & Chemical Instruments Co., Ltd.), with the light condition of a light period (light intensity from 440 to 480 mol/m²/s) of 16 hours/a dark period of 8 hours, a temperature of 30° C. for the light period/25° C. for the dark period, and a humidity of 50%. On day 7 after sowing, the plants were thinned so as to be one plant per pot. Watering was carried out by adding water to a vat placed under the pot so that about 5 cm of the lower part of the pot was submerged after the vat had run out of water.

### (2) Foliar Spray Treatment

Spraying solutions were prepared, and 6.7 mL of each per plant was sprayed only once using a mister on day 14 after sowing. For the preparation of the spraying solutions, BHT was dissolved in isobutyl alcohol and the isobutyl alcohol and sorbitan monolaurate were mixed, which was then dissolved in water. Thereafter, ascorbic acid was dissolved in the water for preparation. The reagents used were the same as those in Example 2. The evaluated test plots 1 to 3 are as follows. On day 21 after sowing, the plant body was dried at 90° C. for 24 hours, and the above-ground part dry weight of the plant body was then measured.
1 plot: control (no application)
2 plot: foliar spray of 1 500 mass ppm ascorbic acid (dissolved in tap water)
3 plot: foliar spray of 1 500 mass ppm ascorbic acid+0.01 mass ppm BHT+50 mass ppm isobutyl alcohol+350 mass ppm sorbitan monolaurate (dissolved in tap water)

### (3) Results

The measurement results of the above-ground part dry weight are shown in FIG. 20. The graph of each figure shows mean±standard deviation.

A comparison between the test plots 2 and 3 indicated that even when the concentration of BHT of the component (B) was 0.01 mass ppm, the addition of the components (B), (C), and (D) to ascorbic acid resulted in a higher growth-promoting effect than when ascorbic acid was applied alone using tap water for dissolution.

### Example 13: Evaluation of Initial Growth Index when Using Anionic Surfactant

The preparation of soil and sowing and the inoculation of Rhizobium were the same as those in Example 2, and the cultivation of soybean was carried out for 21 days.

### (1) Cultivation Conditions

The cultivation was carried out in an artificial weather apparatus (LPH-411SP, Nippon Medical & Chemical Instruments Co., Ltd.), with the light condition of a light period (light intensity from 440 to 480 mol/m/s) of 16 hours/a dark period of 8 hours, a temperature of 30° C. for the light period/25° C. for the dark period, and a humidity of 50%. On day 7 after sowing, the plants were thinned so as to be one plant per pot. Watering was carried out by adding water to a vat placed under the pot so that about 5 cm of the lower part of the pot was submerged after the vat had run out of water.

### (2) Foliar Spray Treatment

On day 14 after sowing, foliar spray treatment was carried out. In addition to the reagents described in Example 2, sodium lauryl sulfate, ammonium lauryl sulfate, and triethanolamine lauryl sulfate were used as anionic surfactants. The reagents were dissolved in tap water to prepare spraying solutions. Foliar spray was carried out only once, and 5 types of test plots were examined (Table 9). Spraying solutions were prepared, and 6.7 mL of each per plant was sprayed using a mister. On day 21 after sowing, the plant body was dried at 90° C. for 24 hours, and the below-ground part dry weight of the plant body was then measured.

TABLE 9

| Spraying solution | | | | | |
|---|---|---|---|---|---|
| Compound (A) | Compound (B) | Compound (C) | Compound (D) | Compound (E) | |
| compound and | compound and | compound and | compound and | compound and | |
| concentration | concentration | concentration | concentration | concentration | Water used |

| | | | | | | |
|---|---|---|---|---|---|---|
| Test plot | 1 | | | | | Tap water |
| of Example | 2 | Ascorbic acid | | | | Tap water |
| | | 1,500 ppm | | | | |
| | 3 | Ascorbic acid | BHT 1 ppm | Isobutanol | Sodium lauryl sulfate | Tap water |
| | | 1,500 ppm | | 50 ppm | 350 ppm | |
| | 4 | Ascorbic acid | BHT 1 ppm | Isobutanol | Ammonium lauryl sulfate | Tap water |
| | | 1,500 ppm | | 50 ppm | 350 ppm | |
| | 5 | Ascorbic acid | BHT 1 ppm | Isobutanol | Triethanolamine lauryl | Tap water |
| | | 1,500 ppm | | 50 ppm | sulfate | |
| | | | | | 350 ppm | |

### (3) Results

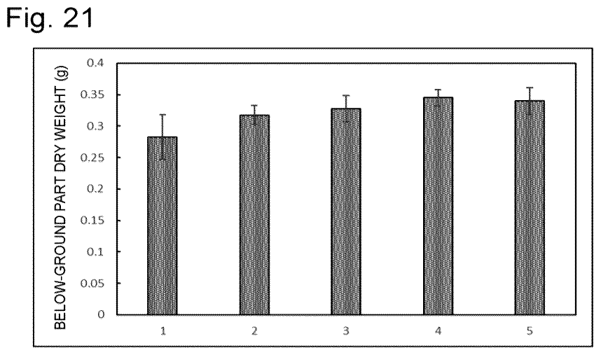

The measurement results of the below-ground part dry weight are shown in FIG. 21. The graph of each figure shows mean±standard deviation. A comparison between the test plots 2, 3, 4, and 5 indicated that even when an anionic surfactant, such as sodium lauryl sulfate, ammonium lauryl sulfate, or triethanolamine lauryl sulfate, was used as the component (D), the addition of the components (B), (C), and (D) to ascorbic acid resulted in a higher growth-promoting effect than when ascorbic acid was applied alone using tap water for dissolution.

### Example 14: Storage stability of one-component formulation

### (1) Preparation of One-Component Composition

Using 300 g of ascorbic acid as the component (A), 0.2 g of BHT as the component (B), 10 mL of isobutyl alcohol as the component (C), and 70 mL of sorbitan monolaurate as the component (D), a one-component composition was produced in the following manner. After the component (B) was dissolved in the component (C), the component (D) was further mixed, and the resulting mixture was mixed with the component (A), thereby producing a one-component composition. The reagents are the same as those in Example 1.

### (2) Preparation of Powder Composition

The carriers shown below were each used as the component (F), and mixed with the one-component composition to produce a powder composition. The content of each component in the obtained powder composition is as shown in Table 10.

Zeolite (Zeolite (powder) manufactured by Zeobuilder Co., Ltd.), silica (Tokusil NP manufactured by Oriental Silicas Corporation), bentonite (Odosorb K-400 manufactured by Kurosaki Hakudo Kogyo K.K.), mirabilite (a dry-ground anhydrous mirabilite sample having an average particle size of 25 m, manufactured by China-Salt Huaian Hongyun Salt Chemical Co., Ltd.).

### (3) Storage Stability Test

After each of the produced powder compositions was stored under room temperature conditions for 1 day, using two sieves with openings of 2.0 mm and 9.5 mm and a tray, the sieves were stacked on the tray starting from the smallest mesh size, 30 g of the composition was added to the top 9.5 mm sieve, the lid was closed, and the container was attached to a mini sieve shaker (manufactured by AS ONE Corporation, shaking speed: 3) and shaken for 10 minutes. Then, the mass of particles remaining on each sieve and on the tray was measured. The mass of particles passing through the 2.0 mm sieve was divided by the total mass to thereby determine the sieve passing rate.

$$Sieve passing rate = ( mass of particles passing through sieve / total mass ) \times 100$$

The results are shown in Table 10. The results of Table 10 reveal that each powder composition has a higher sieve permeability than the comparative examples; that is, the increase in particle size due to surface adhesion during storage is suppressed, thus indicating that the storage stability is excellent.

### (4) Browning Prevention Test

5 g of each of the produced powder compositions was dispensed into transparent glass bottles. The bottles were stored in a storehouse with a set temperature of 50° C. for 2 weeks. 2 weeks later, the degree of browning in appearance was evaluated on a 4-level scale (0: no browning was observed, 1: slight browning was observed, 2: browning was observed, 3: significant browning was observed).

The results are shown in Table 10. The results of Table 10 revealed that browning after storage was prevented in the compositions to which silica was added. In contrast, browning of the appearance was observed in the other compositions. The examination results suggested that the addition of silica is excellent from the viewpoint of appearance stability.

TABLE 10

| | | | Composition | | | | | | | | | | | | Comparative |
|---|---|---|---|---|---|---|---|---|---|---|---|---|---|---|---|
| | | | 1 | 2 | 3 | 4 | 5 | 6 | 7 | 8 | 9 | 10 | 11 | 12 | Example |
| Compounding % | One-component | | 75.0 | 87.5 | 75.0 | 87.5 | 75.0 | 87.5 | 75.0 | 87.5 | 90.00 | 92.5 | 95.0 | 92.5 | 100 |
| | composition | | | | | | | | | | | | | | |
| | Component | Zeolite | 25.0 | 12.5 | | | | | | | | | | | |
| | (F) | Silica | | | 25.0 | 12.5 | | | | | 10.0 | 7.5 | 5.0 | 2.5 | |
| | | Bentonite | | | | | 25.0 | 12.5 | | | | | | | |
| | | Mirabilite | | | | | | | 25.0 | 12.5 | | | | | |

| | | | | | | | | | | | | | |
|---|---|---|---|---|---|---|---|---|---|---|---|---|---|
| Sieve passing rate (%) | 75.9 | 57.4 | 96.8 | 96.9 | 54.2 | 58.4 | 49.7 | 29.1 | 96.7 | 82.9 | 46.5 | 14.2 | 16.2 |
| Degree of browning after | 3 | 3 | 0 | 0 | 2 | 2 | 2 | 2 | 1 | 1 | 1 | 2 | 2 |
| storage at 50° C. | | | | | | | | | | | | | |

1. An agent for leguminous plants included in beans, comprising:
(A) ascorbic acid or a salt thereof;
(B) an antioxidant; and
(C) an organic solvent,
wherein (B) the antioxidant is at least one selected from the group consisting of a tocopherol, dibutylhydroxytoluene, and butylhydroxyanisole,
wherein (C) the organic solvent is at least one selected from the group consisting of an alcohol having at most 5 carbon atoms and dimethylsulfoxide, and
wherein a mass ratio of (A) ascorbic acid or a salt thereof to the component (B) is from 10:1 to 3,000,000:1, or a mass ratio of (C) the organic solvent to the component (B) is from 4:1 to 100,000:1.

2. The agent of claim 1, wherein the mass ratio of (C) the organic solvent to the component (B) is from 4:1 to 100,000:1.

3. The agent of claim 1, wherein the mass ratio of (A) ascorbic acid or a salt thereof to the component (B) is from 10:1 to 3,000,000:1.

4. The agent of claim 1, which is a growth promoter for leguminous plants included in beans.

5. The agent of claim 1, which is a nodule activity promoter.

6. The agent of claim 1, which is a yield enhancer for leguminous plants included in beans.

7. The agent of claim 1, wherein the mass ratio of (A) ascorbic acid or a salt thereof to the component B) is from 10:1 to 3,000,000:1, and the mass ratio of (C) the organic solvent to the component (B) is from 4:1 to 100,000:1.

8. The agent of claim 1, wherein (B) the antioxidant further comprises at least one selected from the group consisting of sodium sulfite, potassium sulfite, glutathione, and uric acid.

9. The agent of claim 1, wherein (C) the organic solvent comprises at least one selected from the group consisting of isobutyl alcohol and dimethylsulfoxide.

10. The agent of claim 1, further comprising (D) a surfactant.

11. The agent of claim 10, wherein a mass ratio of (D) the surfactant to the component (B) is from 10:1 to 300,000:1.

12. The agent of claim 10, wherein (D) the surfactant comprises a nonionic surfactant and/or an anionic surfactant.

13. The agent of claim 12, wherein the nonionic surfactant comprises at least one selected from the group consisting of a sorbitan fatty acid ester, a glycerol fatty acid ester, a polyalkylene glycol fatty acid ester, and a polyoxyethylene alkyl ether, and
wherein the anionic surfactant comprises an alkyl sulfate salt.

14. The agent of claim 12, wherein (D) the surfactant comprises both a nonionic surfactant and an anionic surfactant.

15. The agent of claim 14, wherein the nonionic surfactant comprises at least one member selected from the group consisting of a sorbitan fatty acid ester, a glycerol fatty acid ester, a polyalkylene glycol fatty acid ester, a polyoxyethylene resin acid ester, and a polyoxyethylene alkyl ether, and
wherein the anionic surfactant comprises at least one member selected from the group consisting of an alkyl sulfate salt and a fatty acid salt.

16. The agent of claim 1, further comprising (E) a chelating agent.

17. The agent of claim 16, further comprising (D) a surfactant,
wherein a mass ratio of
the component (A) to the component (B) is from 10:1 to 3,000,000:1,
a mass ratio of the component (C) to the component (B) is from 4:1 to 100,000:1,
a mass ratio of the component (D) to the component (B) is from 10:1 to 300,000:1, and
a mass ratio of the component (E) to the component (B) is from 0.01:1 to 100:1.

18. The agent of claim 16, wherein (E) the chelating agent comprises at least one selected from the group consisting of ethylenediaminetetraacetic acid and ethylenediamine-N,N′-disuccinic acid.

19. The agent of claim 1, further comprising (F) a carrier.

20. The agent of claim 19, wherein a mass ratio of (F) the carrier to the component (B) is from 10:1 to 10,000:1.

21. The agent of claim 19, wherein (F) the carrier comprises at least one selected from the group consisting of zeolite, silica, bentonite, and mirabilite.

22. The agent of claim 1, which comprises a first agent comprising the component (A) and a second agent comprising the components (B) and (C), wherein both first and second agents are combined on use.

23. A method of promoting growth of leguminous plants included in beans, the method comprising:
applying the agent of claim 3, and water in combination to soil or plants.

24. A method of promoting nodule activity, the method comprising:
applying the agent of claim 3 and water in combination to soil or plants.

25. A method of increasing yield of leguminous plants included in beans, the method comprising:
applying the agent of claim 3 and water in combination to soil or plants.

26. The method of claim 23, wherein a first agent comprising the component (A) and a second agent comprising the components (B) and (C) are prepared, and both are combined on use and applied to soil or plants.

27. The agent of claim 22, wherein a weight ratio of the first agent to the second agent is from 1:1 to 100:1.

28. The method of claim 26, wherein the first agent and the second agent are dissolved in water for use.

29. The method of claim 28, wherein a concentration of the first agent in an aqueous solution is 100 mass ppm or more and 300 000 mass ppm or less, and a concentration of the second agent is 10 mass ppm or more and 100 000 mass ppm or less.

30-35. (canceled)

36. The method of claim 24, wherein a first agent comprising the component (A) and a second agent comprising the components (B) and (C) are prepared, and both are combined on use and applied to soil or plants.

37. The method of claim 25, wherein a first agent comprising the component (A) and a second agent comprising the components (B) and (C) are prepared, and both are combined on use and applied to soil or plants.
